(19) United States
(12) Patent Application Publication
(10) Pub. No.: US 2020/0165392 A1
(43) Pub. Date: May 28, 2020

(54) AROMATIC SULFONE POLYMERS COMPRISING (PER)FLUOROPOLYETHER SEGMENTS

(71) Applicant: SOLVAY SPECIALTY POLYMERS ITALY S.P.A., Bollate (IT)

(72) Inventors: Ritu AHUJA, Singapore (SG); Trupti NALAWADE, Sayajipura, Vadodara (IN); Emanuele DI NICOLO', Gorla Minore (IT); Giovanni FONTANA, Paderno Dugnano (IT); Ivan Diego WLASSICS, Garessio (IT); Giuseppe MARCHIONNI, Milano (IT); Claudio Adolfo Pietro TONELLI, Paderno d'Adda (IT)

(21) Appl. No.: 16/608,179

(22) PCT Filed: Apr. 19, 2018
(86) PCT No.: PCT/EP2018/060100

§ 371 Date: Oct. 24, 2019

(30) Foreign Application Priority Data
Apr. 24, 2017 (IN) 201721014518
Jun. 14, 2017 (EP) 17176030.9

(51) Int. Cl. C08G 75/23; C08G 65/40; C08G 65/334; B01D 71/80; B01D 61/24; B01D 69/04; B01D 69/08

(52) U.S. Cl. CPC C08G 75/23; C08G 65/40; C08G 65/3346; B01D 2325/02; B01D 61/246; B01D 69/04; B01D 69/08; B01D 71/80

(57) ABSTRACT

A fluorinated aromatic sulfone polymer [polymer (F-PS)] comprising: recurring units [units (A)] derived from at least one dihalo-diaryl sulfone [monomer (A)]; recurring units [units (B)] derived from at least one aromatic diol [monomer (B)]; at least one unit [units (PFPE)] derived from at least one fully or partially fluorinated polyether alcohol (PFPE alcohol), said polymer (F-PS) having a fluorine content ranging from 0.1% to 10% wt, is herein disclosed. Films and membranes obtained from (F-PS) are also disclosed, as well as their use in filtration methods.

### CROSS-REFERENCE TO RELATED APPLICATIONS

This application claims priority to Indian provisional application No. 201721014518 filed on Apr. 24, 2017 and to European application No. 17176030.9 filed Jun. 14, 2017, the whole content of each of these applications being incorporated herein by reference for all purposes.

### TECHNICAL FIELD

The present invention relates to aromatic sulfone polymers and uses thereof, in particular to their use in the manufacture of films and membranes.

### BACKGROUND ART

Porous membranes are discrete, thin interfaces that moderate the permeation of chemical species in contact with them. The key property of porous membranes is their ability to control the permeation rate of chemical species through the membrane itself. This feature is exploited in many different applications like separation applications (water and gas) or biomedical applications. Polymeric membranes suitable for use as microfiltration and ultrafiltration typically control the permeation under a “sieve” mechanism, wherein the passage of liquid or gas is mainly governed by a convective flux.

Such polymeric membranes are mainly produced by phase inversion methods which allow obtaining items with very large fraction of voids (porosity).

For this purpose, a homogeneous polymeric solution (also referred to as “dope solution”) containing a polymer, a suitable solvent and/or a co-solvent and, optionally, one or more additives, is typically casted into a film and then precipitated by contact with a non-solvent medium, in the so-called Non-Solvent Induced Phase Separation (NIPS) process. The non-solvent medium is usually water or a mixture of water and surfactants, alcohols and/or the solvent itself.

Precipitation can also be induced by decreasing the temperature of a polymeric solution, in the so-called Thermal Induced Phase Separation (TIPS) process.

Alternatively, in the so-called Vapour Induced Phase Separation (VIPS) process, precipitation can be induced by contacting a film obtained by casting with air having very high water vapour content.

Still, precipitation may be induced by evaporation of the solvent from a film obtained by casting, in the so-called Evaporation Induced Phase Separation (EIPS) process. Typically in this process an organic solvent with low boiling point (such as tetrahydrofuran, acetone, methyl-ethyl-ketone and the like) is used in admixture with water (the so called “non-solvent”) for the preparation of the polymer solution. The polymer solution is first extruded and then precipitates due to the evaporation of the volatile solvent and the enrichment of the non-solvent.

The above processes can be used in combination and/or in sequence to provide membranes having specific morphology and performances. For example, EIPS process can be combined with the VIPS process and NIPS process in order to complete the precipitation process.

Aromatic sulfones polymers are high performance polymers endowed with high mechanical strength and high thermal stability; they are used in a variety of industrial applications, including the manufacture of microfiltration membranes and ultrafiltration membranes, such as those used in the biomedical field. For example, micro-porous membranes used in the manufacture of haemodialysis devices can be obtained by spinning filaments from a dope solution (otherwise referred to as “spinning solution”) comprising the polymer, a solvent, a pore-forming agent and a surface-modifying macromolecule, as disclosed, for example, in US 2011/009799 A (INTERFACE BIOLOGICS, INC.).

Materials used for the manufacture of haemodialysis membranes must be endowed with high hydro-/oleo-repellence in order to avoid the penetration of the blood filtration water and of any possible contaminants (like pyrogens) that might be present in the water and that might induce adverse reactions in the patients. Moreover and more important, materials used for the manufacture of haemodialysis membranes must not induce blood coagulation. Even though the aromatic sulfone polymers currently used in the manufacture of microfiltration and ultrafiltration membranes meet these requirements, there is the continuous need to obtain improved materials for the manufacture of haemodialysis membranes.

It is known in the art that fully or partially fluorinated polyethers (herein after “PFPEs”) can be used as additives for other polymers in order to modify certain physical/chemical properties of the host polymer. However, it has been observed that, when PFPEs are physically blended to other polymers, PFPEs tend to segregate and to migrate to the surface during polymer processing; in some instances, the separation of the PFPEs from the composition might reduce the durability of the composition and of the finished article obtained therefrom. Moreover, in several applications (e.g. biomedical applications), the risk of separation of chemical components from compositions represents a toxicological concern, so the use of PFPEs as additives is not acceptable.

It is also known in the art that PFPEs can be used as co-reagents in polymerization processes, thereby obtaining modified polymers having PFPE segments covalently incorporated therein. For example, patent documents EP 1864685 A (SOLVAY SOLEXIS S.P.A.), U.S. Pat. No. 5,476,910 (AUSIMONT S.P.A.), U.S. Pat. No. 5,686,522 (AUSIMONT S.P.A.) and U.S. Pat. No. 5,109,103 (AUSIMONT S.P.A.) disclose polyurethanes (PUs), polyurethane/polyesters (PUs/PEs) or polyesters (PEs) that are modified with PFPEs. U.S. Pat. No. 6,127,498 (AUSIMONT S.P.A.) discloses hydrogenated fluoromodified polymers obtained by polycondensation, polyaddition or grafting reaction of a mono-functional perfluoropolyether and a hydrogenated polymer. WO 2009/010533 A (SOLVAY SOLEXIS S.P.A.) discloses aromatic hydrogenated polymers comprising PFPE segments that are introduced in the hydrogenated polymer using a PFPE peroxidic precursor.

U.S. Pat. No. 5,508,380 (AUSIMONT S.P.A.) discloses thermoplastic elastomeric polymers containing PFPE segments. As polymers, this document specifically mentions, polyurethanes, polyethers, polyamides, polyureas, polyamides, polyimides, polytriazines, polysulfides and polysiloxanes. No mention is made of aromatic polysulfones; moreover, the content of fluorinated segments in the polymers is high.

WO 2015/097076 (SOLVAY SPECIALTY POLYMERS ITALY SPA) discloses a thermoplastic polyamide obtained using as co-reagent in polymerization a PFPE diamine or a PFPE dicarboxylic acid in an amount ranging from 0.1% to 10% wt with respect to the overall weight of monomers.

U.S. Pat. No. 6,348,152 (TEIJIN LIMITED) relates to a medical material composed of a poly(alkyl aryl ether)sulfone copolymer (A) and a thermoplastic polymer (B) different from copolymer (A). Copolymer (A) contains fluorinated blocks of formula:

—(Ar₃—Y—Ar₄—O)—

wherein Ar₃ and Ar₄ are each independently a bivalent aromatic group having 6 to 30 carbon atoms which may have a substituent group; Y is an alkylene group having 1 to 18 carbon atoms, at least one of its hydrogen atoms being substituted with a fluorine atom. Copolymer (A) comprises also polyoxyalkylene blocks, but such blocks are not fluorinated.

It is thus a further object of the present invention to provide a convenient process for the manufacture of aromatic sulfone polymers having PFPE segments covalently incorporated therein, in particular PFPE segments derived from PFPEs having —CF₂CH₂OH or —CF(CF₃)CH₂OH end groups.

US 2016/0075850 discloses to a method for preparing polyarylether-sulfone-polyalkylene oxide block co-polymers.

EP 0781795 relates to a polyalkyl ether/polyaryl ether sulfone or ketone co-polymer and a specific polyether ester copolymer for producing a medical material suitable to be used in contact with blood.

WO 2014/0195234 relates to a membrane comprising a block copolymer comprising polyarylene ether blocks and polyalkylene oxide blocks.

EP 1026190 relates to a medical material composed of a poly(alkyl aryl ether) sulfone co-polymer (A) and a thermoplastic polymer (B), to be used in contact with blood. Said sulfone co-polymer comprises fluorine in units derived from condensation of dihalodisulfone monomers and fluorine-contaning diphenol derivatives, in particular 4,4′-haxafluoroisopropylidenediphenol, and polyoxyalkylene units.

U.S. Pat. No. 5,798,437 discloses an amphiphilic block co-polymer including a hydrophilic internal segment and polymeric articles made therefrom, in particular internal segments of PEO or PPO.

EP 1864685 pertains to a process for the manufacture of a medical implant, which comprises the reaction of a PFPE polymer having hydroxyl end groups with suitable reactants, such as notably polyurethane polymer or polyester polymer, to produce a thermoplastic elastomer, which is then molded to provide said medical implant.

WO 2016/083279 discloses bifunctional fluorinated polymers comprising a plurality of PFPE segments and the use thereof in lubricant compositions or compositions for imparting oleo- and hydro-repellence to a substrate.

WO 2017/076767 discloses a method for providing a fluorinated polyamide comprising the reaction of a (per)fluoropolyether comprising amino or acid functional groups with a mixture of dicarboxylic acid(s), diamine(s) and/or aminoacid(s)/lactam(s).

WO 2015/097076 discloses polyamides comprising unites derived from a (per)fluoropolyether carboxylic diacid or a (per)fluoropolyether diamine, which possess improved chemical resistance and reduced brittleness.

### SUMMARY OF INVENTION

The Applicant has found out that aromatic sulfone polymers comprising fully or partially fluorinated segments covalently incorporated therein are endowed with high hydro-/oleo-repellence and can be conveniently used in the manufacture of films and membranes, in particular in the manufacture of filtration membranes for biological uses.

Thus, in a first aspect, the present invention relates to a fluorinated aromatic sulfone polymer [polymer (F-PS)] comprising, preferably consisting of:
recurring units [units (A)] derived from at least one dihalo-diaryl sulfone [monomer (A)];
recurring units [units (B)] derived from at least one aromatic diol [monomer (B)];
at least one unit [unit (PFPE)] derived from at least one fully or partially fluorinated polyether alcohol (PFPE alcohol),
   said polymer (F-PS) having a fluorine content ranging from 0.1% to 10% wt.

In a further aspect, the present invention relates to a process [process (P)] for the synthesis of polymer (F-PS).

In a further aspect, the present invention relates to a composition [composition (C)] comprising one or more polymer (F-PS) in admixture with further ingredients.

In a further aspect, the present invention relates to a film [film (F)] comprising at least one layer obtained from of a composition (C) as defined above and to methods for the manufacture film (F).

Advantageously, film (F) is a discrete, generally thin, dense layer.

In a further aspect, the invention relates to a membrane [membrane (M)], preferably a porous membrane, comprising at least one layer obtained from a composition (C) and to methods for the manufacture of membrane (M).

### DESCRIPTION OF EMBODIMENTS

### Definitions

For the purposes of the present description:
the term “(per)fluoropolyether” is intended to indicate a “fully or partially fluorinated polyether”;
the expression “(per)fluoropolyoxyalkylene chain” is intended to indicate a partially or fully fluorinated, straight or branched, polyoxyalkylene chain;
the acronym “PFPE” stands for (per)fluoropolyether;
the use of parentheses before and after symbols or numbers identifying compounds, chemical formulae or parts of formulae has the mere purpose of better distinguishing those symbols or numbers from the rest of the text and hence said parentheses can also be omitted;
unless otherwise indicated, the term “halogen” includes fluorine, chlorine, bromine or iodine and “halogenated” means containing one or more of fluorine, chlorine, bromine and iodine atoms;
the term “membrane” is intended to indicate to a discrete, generally thin, interface that moderates the permeation of chemical species in contact with it, said membrane containing pores of finite dimensions;
the term “porous” is intended to indicate that a membrane of the invention contains pores distributed throughout its thickness;
the term “dense” associated to “film” or “layer” is intended to indicate that the film or the layer does not contain pores distributed throughout its thickness or, if pores are present, the gravimetric porosity is of less than 3%, more preferably less than 1%, based on the total volume of the film;
the term “composition (C)” is intended to include both a liquid composition [composition (C^{L})] and a solid composition [composition (C^{S})], unless otherwise specified;
the expression “as defined above” is intended to comprise all generic and specific or preferred definitions or embodiments referred to by that expression in preceding parts of the description;
the term “process” and “method” are synonyms;
unless indicate otherwise, when ranges are indicated, range ends are included;
the adjective “aromatic” denotes any mono- or polynuclear cyclic group (or moiety) having a number of π electrons equal to 4n^{∘}+2, wherein n^{∘} is 0 or any positive integer; an aromatic group (or moiety) can be an aryl or an arylene group (or moiety);
an “aryl group” is a hydrocarbon monovalent group consisting of one core composed of one benzenic ring or of a plurality of benzenic rings fused together by sharing two or more neighboring ring carbon atoms, and of one end. The end of an aryl group is a free electron of a carbon atom contained in a (or the) benzenic ring of the aryl group, wherein an hydrogen atom linked to said carbon atom has been removed. The end of an aryl group is capable of forming a linkage with another chemical group;
an “arylene group” is a hydrocarbon divalent group consisting of one core composed of one benzenic ring or of a plurality of benzenic rings fused together by sharing two or more neighboring ring carbon atoms, and of two ends. An end of an arylene group is a free electron of a carbon atom contained in a (or the) benzenic ring of the arylene group, wherein an hydrogen atom linked to said carbon atom has been removed. Each end of an arylene group is capable of forming a linkage with another chemical group.

The Fluorinated Aromatic Polysulfone [Polymer (F-PS)]

As stated above, polymer (F-PS) comprises, preferably consists of:
recurring units [units (A)] derived from at least one dihalo-diaryl sulfone [monomer (A)];
recurring units [units (B)] derived from at least one aromatic diol [monomer (B)];
at least one unit [unit (PFPE)] derived from at least one fully or partially fluorinated polyether alcohol (PFPE alcohol), said polymer (F-PS) having a fluorine content ranging from from 0.1% to 10% wt.

The fluorine content is determined according to methods known in the art, preferably by ion combustion chromatography as reported in the Experimental Section further below.

For the avoidance of doubt, the expression “at least one” as referred to monomer (A), (B) and PFPE alcohol means that mixtures of monomers (A) and/or (B) and/or PFPE alcohols can be used in the synthesis of polymer (F-PS).

Recurring units (A), (B) and the at least one unit PFPE are randomly distributed in polymer (F-PS).

For the avoidance of, the expression “(recurring) units derived from . . . ” identifies units formed by ethereal linkage between monomers (A), (B) and PFPE alcohol.

The at least one monomer (A) typically complies with formula (A-I) here below:

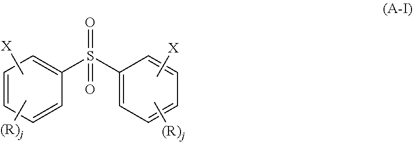

wherein:
each X, equal to or different from one another, is halogen;
each R, equal to or different from one another, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j, equal to or different from one another, is zero or is an integer from 1 to 4.

Preferably, both X are fluorine or chlorine, more preferably fluorine.

Preferably, both j are zero.

In a preferred embodiment, both X are chlorine and both j are 0; more preferably, the chlorine substituents are at the 4-,4′ positions, so a preferred monomer (A-1) is 4,4′-difluorodiphenylsulfone.

The at least one monomer (B) is a diol HO—R_{diol}—OH, wherein R^{∘}_{diol} is independently selected from the following classes:

(a) a straight or branched hydrocarbon chain containing from 2 to 20 carbon atoms, optionally substituted with one or more hydroxyl groups and optionally interrupted by one or more arylene groups and/or heteroatoms independently selected from N, O and S;

(b) a C₃-C₁₂ cycloalkyl or a C₆-C₁₂ bicycloalkyl group, each optionally containing one or more heteroatoms independently selected from N, O and S and optionally substituted with one or more C₁-C₄ straight or branched alkyl groups and

(c) a group of formula —Ar¹-(T-Ar²)_{nT}—, wherein:
Ar¹ and Ar², equal to or different from one another at each occurrence, are independently an arylene group as defined above and
T is selected from the group consisting of: a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

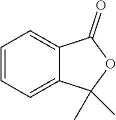

and n_{T} is 0 or an integer of 1 to 5;

(d) a 1,4:3,6-dianhydrohexitol sugar diol residue, in particular an isosorbide, isomannide or isoiodide residue, respectively complying with the formulae (Bd-1)-(Bd-3) here below:

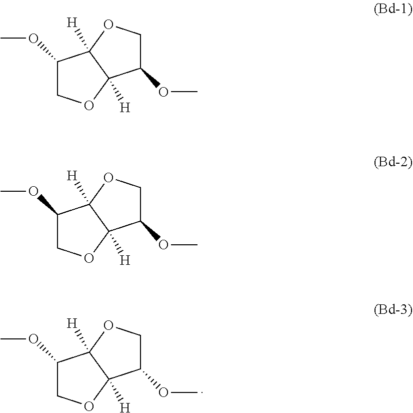

Preferred monomers (B) wherein R^{∘}_{diol} belongs to class (a) [monomers (Ba)] are those wherein R^{∘}_{diol} is a straight alkylene chain interrypted by one phenylene group. A convenient example of monomer (Ba) is 1,4-bis(2-hydroxyethyl)benzene.

Preferred monomers (B) wherein R^{∘}_{diol} belongs to class (c) [monomers (Bc)] are those wherein Ar¹ and Ar² are phenylene groups and n is 0 or one. Preferred monomers (Bc) are also those wherein n is 0.

Preferred monomers (Bc) are also those wherein T is selected from a bond, —CH₂—, —C(O)—, —C(CH₃)₂— and —SO₂—, and n is 1. Preferably, monomer (Bc) is 4,4′-dihydroxy diphenyl, 2,2-bis(4-hydroxyphenyl)propane, 4,4′-dihydroxydiphenylsulfone or 4,4′dihydrohydiphenylketone.

In one preferred embodiment, polymer (F-PS) comprises recurring units deriving from at least one monomer (Ba) and from at least one monomer (Bc).

In another preferred embodiment, polymer (F-PS) comprises recurring units deriving from at least one monomer (Bc).

The at least one PFPE alcohol is a hydroxy-terminated (per)fluoropolyether polymer, i.e. a polymer comprising a (per)fluoropolyoxyalkylene chain [chain (R_{f})] having two chain ends, wherein one or both chain ends bear a terminal group comprising at least one —OH group. Preferably, one or both chain ends bear a terminal group comprising one —OH group.

Typically, chain (R_{f}) has a number average molecular weight (Mn) ranging from 400 to 10,000 Da, preferably from 400 to 2,000 Da and comprises recurring units (R^{∘}) selected from:

(i) —CFX^{∘}O—, wherein X^{∘} is F or CF₃;

(ii) —CFX^{∘}CFX^{∘}O—, wherein X^{∘}, equal or different at each occurrence, is F or CF₃, with the proviso that at least one of X^{∘} is F;

(iii) —CF₂CF₂CW^{∘}₂O—, wherein each of W^{∘}, equal or different from each other is F, Cl, H;

(iv) —CF₂CF₂CF₂CF₂O—;

(v) —(CF₂)ⱼ_{^{∘}}—CFZ^{∘}—O— wherein j^{∘} ranges from 0 to 3 and Z^{∘} is a group of general formula —OR_{f}^{∘}T^{∘}, wherein R_{f}^{∘} is a fluoropolyoxyalkene chain comprising a number of repeating units from 0 to 10, said recurring units being chosen among the followings: —CFX^{∘}O—, —CF₂CFX^{∘}O—, —CF₂CF₂CF₂O—, —CF₂CF₂CF₂CF₂O—, with each of each of X^{∘} being independently F or CF₃ and T^{∘} being a C₁-C₃ perfluoroalkyl group.

Preferably, chain (R_{f}) complies with the following formula:

—(CFX^{∘1}O)_{g1}(CFX^{∘2}CFX^{∘3}O)_{g2}(CF₂CF₂CF₂O)_{g3}(CF₂CF₂CF₂CF₂O)_{g4}— (R_{f}-I)

wherein:
X^{∘1} is independently selected from —F and —CF₃;
X^{∘2}, X^{∘3}, equal or different from each other and at each occurrence, are independently —F, —CF₃, with the proviso that at least one of X is —F;
g1, g2, g3, and g4, equal or different from each other, are independently 0 or integers >0, wherein g1+g2+g3+g4 is selected in such a way as chain (R_{f}) has number average molecular weight ranging from 400 to 10,000 Da, preferably from 400 to 2,000 Da; should at least two of g1, g2, g3 and g4 be different from zero, the different recurring units are generally statistically distributed along the chain.

More preferably, chain (R_{f}) is selected from chains of formula:

—(CF₂CF₂O)ₐ₁(CF₂O)ₐ₂— (R_{f}-IIA)

wherein:
a1 and a2 are independently 0 or integers >0 such that the number average molecular weight ranges from 400 to 10,000 Da, preferably from 400 to 2,000 Da; both a1 and a2 are preferably different from zero, with the ratio a1/a2 preferably ranging from 0.1 to 10;

—(CF₂CF₂O)_{b1}(CF₂O)_{b2}(CF(CF₃)O)_{b3}(CF₂CF(CF₃)O)_{b4}— (R_{f}-IIB)

wherein:

b1, b2, b3, b4, are independently 0 or integers >0 such that the number average molecular weight ranges from 400 to 10,000 Da, preferably from 400 to 2,000 Da; preferably b1 is 0, b2, b3, b4 are >0, with the ratio b4/(b2+b3) being ≥1;

—(CF₂CF₂O)_{c1}(CF₂O)₂(CF(CCF₂(CF₂)_{cw}CF₂O)_{c3}— (R_{f}-IIC)

wherein:

cw=1 or 2;

c1, c2, and c3 are independently 0 or integers >0 chosen so that the number average molecular weight ranges from 400 to 10,000 Da, preferably from 400 to 2,000 Da; preferably c1, c2 and c3 are all >0, with the ratio c3/(c1+c2) being generally lower than 0.2;

—(CF₂CF(CF₃)O)_{d}— (R_{f}-IID)

wherein:

d is an integer >0 such that the number average molecular weight ranges from 400 to 10,000 Da, preferably from 400 to 2,000 Da

—(CF₂CF₂C(Hal)₂O)ₑ₁—(CF₂CF₂CH₂O)ₑ₂—(CF₂CF₂CH(Hal)O)ₑ₃— (R_{f}-IIE)

wherein:
Hal, equal or different at each occurrence, is a halogen selected from fluorine and chlorine atoms, preferably a fluorine atom;
e1, e2, and e3, equal to or different from each other, are independently 0 or integers >0 such that the (e1+e2+e3) sum is ranges from 2 to 300.

Still more preferably, chain (R_{f}) complies with formula (R_{f}-III) here below:

—(CF₂CF₂O)ₐ₁(CF₂O)ₐ₂— (R_{f}-III)

wherein:
a1, and a2 are integers >0 such that the number average molecular weight ranges from 400 to 10,000 Da, preferably from 400 to 2,000 Da, with the ratio a2/a1 generally ranging from 0.2 to 5.

Preferred PFPE alcohols for use in the present invention comply with formula (PFPE-1) here below:

Z—O—R_{f}—Z (PFPE-1)

wherein (R_{f}) is a fluoropolyoxyalkylene chain as defined above and each Z, equal to or different from one another, represents (i) a hydrocarbon group containing one hydroxy group, said hydrocarbon group being partially fluorinated and optionally containing one or more ethereal oxygen atoms, or (ii) a C₁-C₃ haloalkyl group, typically selected from —CF₃, —CF₂Cl, —CF₂CF₂Cl, —C₃F₆Cl, —CF₂Br, —CF₂CF₃ and —CF₂H, —CF₂CF₂H.

Preferred groups Z comply with formula (Z-1) here below:

—CFX^{∘}CH₂(OCH₂CHY)ₙOH (Z-1)

wherein:
X^{∘} is F— or CF₃—, preferably F;
Y is hydrogen or methyl and
n is 0 or an integer equal to or higher than 1, preferably ranging from 1 to 10.

Preferred PFPE alcohols (PFPE-1) are those wherein (R_{f}) complies with formula (R_{f}-III) as defined above, X^{∘} is F—, Y is H and n is 0 or is an integer ranging from 1 to 10; most preferably, n is 0 or 1.

Preferred PFPE alcohols (PFPE-1) wherein n is 0 can be obtained according to known methods, for example as disclosed in EP 1614703 A (SOLVAY SOLEXIS S.P.A.) 11 Jan. 2006.

Preferred PFPE alcohols (PFPE-1) wherein n is equal to or higher than 1 can be obtained from a PFPE alcohol (A-1) wherein n is 0 by reaction with ethylene oxide or propylene oxide in the presence of a base. In particular, PFPE alcohols (PFPE-1) comprising groups Z complying with formula (Z-1) in which n ranges from 1 to 10 can be conveniently manufactured with the method disclosed in WO 2014/090649 A (SOLVAY SPECIALTY POLYMERS ITALY) 19 Jun. 2014.

Typically, PFPE alcohols (PFPE-1) are available as mixtures of mono- and di-functional alcohols, and, optionally, non-functional PFPEs in a molar amount lower than 0.04%, said mixtures being defined by an average functionality (F). The average functionality [herein after (F_{OH})] of PFPE alcohols is the average number of hydroxy groups per alcohol molecule; PFPE alcohols (PFPE-1) suitable for the synthesis of the (F-PS) of the present invention have a functionality (F_{OH}) ranging from 1.8 to 2. Average functionality (F_{OH}) can be calculated according to methods known in the art, for example as disclosed in EP 1810987 A (SOLVAY SOLEXIS S.P.A.) 25 Jul. 2007.

### Synthesis of the (F-PS) Polymers

A further object of the present invention is a process [process (P)] for the manufacture of polymers (F-PS).

Process (P) comprises the copolymerization reaction of a PFPE alcohol as defined above, preferably a PFPE alcohol (PFPE-1), with:
at least one monomer (A) and at least one monomer (B);
and/or with a hydroxyl or halogen-terminated aromatic sulfone polymer free from units (PFPE) [herein after “reactive PS” or “(r-PS)” ], said polymer being obtained by copolymerization reaction of at least one monomer (A) and at least one monomer (B), said at least one monomer (A) and at least one monomer (B) being the same or different from those of (F-PS).

In one preferred embodiment, process (P) is a process [process (P1)] that comprises the following steps:

(a_{P1}) reacting a PFPE alcohol with a monomer (A) [step (a_{P1}-i)] or reacting a disulfonic ester of a PFPE alcohol with a monomer (B) [step (a_{P1}-ii)] to respectively provide a PFPE oligomer (OL-A) or (OL-B);

(a′_{P1}) optionally reacting a PFPE oligomer (OL-A) from step (a_{P1}-i) with a monomer (B) to provide a PFPE oligomer (OL-AB) [step (a′_{P1})]; or

(a″_{P1}) optionally reacting a PFPE oligomer (OL-B) from step (a_{P1}-ii) with monomer (A) to provide a PFPE oligomer (OL-BA) and

(b_{P1}) copolymerizing the PFPE oligomer from step (a_{P1}), (a′_{P1}) or (a″_{P1}) [herein after PFPE oligomer (OL_{P1})] with at least one monomer (A) and at least one monomer (B) wherein the equivalent ratio PFPE

oligomer (OL_{P1})/[monomer (A)+monomer (B)] is selected in such a way as the fluorine content of the resulting polymer (F-PS) ranges from 0.1% to 10% wt. A person skilled in the art will be able to determine such ratio on the basis of the molecular weight and fluorine content of the PFPE oligomer (OL_{P1}) and molecular weights of monomers (A) and (B); or

(b′_{P1}) copolymerizing a PFPE oligomer (OL_{P1}) with a (r-PS) as defined above, wherein the equivalent ratio PFPE oligomer (OL_{P1})/[(r-PS)] is selected in such a way as the fluorine content of the resulting (F-PS) polymer ranges from 0.1% to 10% wt. A person skilled in the art will be able to determine such ratio on the basis of the molecular weight and fluorine content of the PFPE oligomer (OL_{P1}) and molecular weight of (r-PS).

In one embodiment, process (P1) comprises a step (a_{P1}-i) wherein a PFPE alcohol is reacted with monomer (A) to provide a PFPE oligomer (OL-A). This reaction can be carried out with or without solvent and is carried out in the presence of an inorganic base, typically an alkali metal carbonate, for example Na₂CO₃ or K₂CO₃. According to this embodiment, when a monomer (A-I) is used, step (a_{P1}-i) provides a PFPE oligomer (OL-A) comprising at least one terminal group of formula (Z^{∘}):

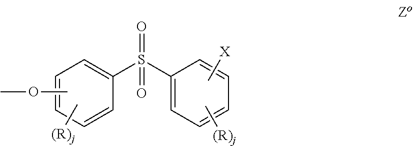

wherein R, j and X are as defined above.

When a PFPE alcohol (PFPE-1) comprising end groups of formula (Z-1) as defined above is used in step (a_{P1}-i), the oligomer (OL-A) comprises at least one terminal group of formula (Z^{∘}-1a):

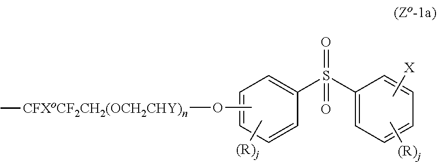

wherein X^{∘}, Y, n, R, j and X are as defined above.

According to a preferred embodiment, step (a_{P1}-i) is carried using 4,4′-difluorodiphenylsulfone or 4,4′-dichlorodiphenylsulfone as monomer (A).

In another embodiment, process (P-1) comprises a step (a_{P1}-ii) wherein a sulfonic ester of a PFPE alcohol is reacted with monomer (B) to provide an oligomer (OL-B). A sulfonic ester of a PFPE alcohol can be obtained by reaction of a PFPE alcohol with a sulfonyl halide of formula R^{su}—SO₂—X^{su} wherein:
R^{su} is selected from fully or partially halogenated straight of branched alkyl, preferably C₁-C₄ alkyl, and aryl, preferably phenyl, optionally substituted with one or more partially halogenated straight of branched alkyl and/or more halogens; and
X^{su} is halogen, preferably chlorine or fluorine, more preferably fluoride.

Convenient examples of sulfonyl halides R^{su}—SO₂—X^{su} are nonafluorobutanesulfonyl fluoride and p-toluene sulfonyl fluoride.

The conversion of a PFPE alcohol into a corresponding PFPE sulfonic ester can be carried out according to methods known in the art, for instance following the teaching of TONELLI, Claudio, et al. Linear perfluoropolyethers difunctional oligomers: chemistry, properties and applications. Journal of Fluorine Chemistry. 1999, vol. 95, p. 51-70. Also the reaction of the PFPE sulfonic ester with monomer (B) is carried out according to methods known in the art; typically, such reaction is carried out in a polar aprotic solvent, for example dimethylsulfoxide, in the presence of an inorganic base, typically an alkali metal carbonate, for example Na₂CO₃ or K₂CO₃.

According to this embodiment, step (a_{P1}-ii) provides a PFPE oligomer (OL-B) comprising terminal groups of formula: —O—R^{∘}—OH, wherein R^{∘} is as defined above.

When a sulfonic ester of a PFPE alcohol comprising end groups of formula (Z-1) is used in step (a_{P1}-ii), a PFPE oligomer (OL-B) is obtained comprising terminal groups of formula (Z^{∘}-1b):

—CFX^{∘}CH₂(OCH₂CHY)ₙOR^{∘}—OH (Z^{∘}-1b)

wherein X^{∘}, Y, n and R^{∘} are as defined above.

Convenient examples of monomers (B) to be used in step (a_{P1}-ii) are 4,4′-dihydroxy diphenyl, 2,2-bis(4-hydroxyphenyl)propane 4,4′-dihydroxydiphenylsulfone and 4,4′-dihydroxydiphenylketone.

When a PFPE oligomer (OL-A) from step (a_{P1}-i) having terminal groups (Z^{∘}) is reacted with monomer (B) according to step (a_{P1}′), a PFPE oligomer (OL-AB) is obtained comprising terminal groups of formula (Z^{∘∘}):

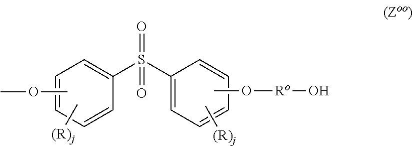

wherein R, j and R^{∘} are as defined above.

When a PFPE alcohol comprising end groups of formula (Z-1) is used in step (a_{P1}-i), a PFPE oligomer (OL-AB) obtained in step (a′_{P1}) comprises terminal groups of formula (Z^{∘∘}-1):

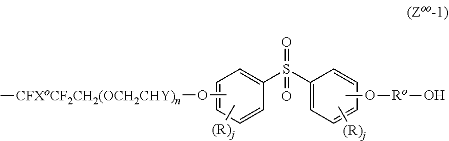

wherein X^{∘}, Y, n, R, j and R^{∘} are as defined above.

When a PFPE oligomer (OL-B) from step (a_{P1}-ii) is reacted with monomer (A-I) according to step (a_{P1}″), a PFPE oligomer (OL-BA) is obtained comprising terminal groups of formula (Z^{∘}*-1):

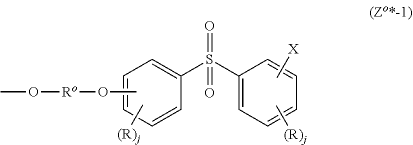

wherein R^{∘}, R, j and X are as defined above.

When a sulfonic ester of a PFPE alcohol comprising end groups of formula (Z-1) is used in step (a_{P1}-ii), a PFPE oligomer (OL-BA) is obtained comprising end groups of formula (Z^{∘}*-1a):

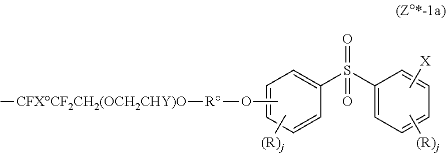

wherein X^{∘}, Y, R^{∘}, R, j and X are as defined above.

According to a convenient embodiment, step (a_{P1}-ii) is carried out using a monomer (B) selected from 4,4′-dihydroxy diphenyl, 4,4′-dihydroxydiphenylsulfone and 4,4′-dihydroxydiphenylketone and step (a_{P1}″) is carried out using 4,4-dihydroxy-diphenyl sulfone as monomer (A).

In another embodiment, process (P) is a process [process (P2)] that comprises the following steps:

(a_{P2}) reacting a PFPE alcohol with a sulfonic diester of a monomer (B) to provide a sulfonyl-terminated PFPE oligomer (OL-B_{SU});

(a′_{P2}) reacting oligomer (OL-B_{SU}) from step (a_{P2}) with a monomer (B) to provide an oligomer (OL-BB);

(b_{P2}) submitting oligomer (OL-BB) from step (a′_{P2}) to a polyconsensation reaction with at least one monomer (A) and at least one monomer (B) wherein the equivalent PFPE oligomer (OL-BB)/[monomer (A)+monomer (B)] is selected in such a way as the fluorine content of the resulting (F-PS) polymer ranges from 0.1% to 10% wt. A person skilled in the art will be able to determine such ratio on the basis of the molecular weight and fluorine content of the PFPE oligomer (OL-BB) and molecular weights of monomers (A) and (B)

or

(b′_{P2}) reacting the PFPE oligomer (OL-BB) from step (a′_{P2}) with a hydroxyl or halogen-terminated (r-PS) as defined above, wherein the equivalent ratio PFPE oligomer (OL-BB)/(r-PS) is selected in such a way as the fluorine content of the resulting (F-PS) polymer ranges from 0.1% to 10% wt. A person skilled in the art will be able to determine such ratio on the basis of the molecular weight and fluorine content of the PFPE oligomer (BB) and molecular weight of (r-PS).

A sulfonic diester of a monomer (B) can be obtained by reacting a monomer (B) with at least two equivalents of a sulfonyl halide R^{su}—SO₂—X^{su} wherein R^{su} and X^{su} are as defined above. Thus, a sulfonic diester of monomer (B) complies with formula (B^{su}) here below:

(B^{su})R^{su}—SO₂—O—R^{∘}—O—SO₂—R^{su}

wherein R^{su} is as defined above.

The resulting sulfonyl-terminated PFPE oligomer (OL-B_{SU}) from step (a_{P2}) thus comprises terminal groups of formula (Z**):

—O—R^{∘}—O—SO₂—R^{su} (Z**)

wherein R^{su} is as defined above.

When a PFPE alcohol comprising terminal groups (Z-1) is used in step (a_{P2}), the PFPE oligomer (OL-B_{SU}) comprises terminal groups of formula (Z**-1)

—CFX^{∘}CH₂(OCH₂CHY)ₙ—O—R^{∘}—O—SO₂—R^{su} (Z**-1)

wherein X^{∘}, Y, R^{∘} and R^{su} are as defined above.

According to a preferred embodiment of process (P2), in step (a_{P2}), the sulfonic diester of a monomer (B) is a sulfonic ester of 1,4-bis(2-hydroxyethyl)benzene and in step (a′_{P2}) monomer (B) is 4,4′-dihydroxy diphenyl.

Steps (b_{P1}) and (b_{P2}) are carried out according to methods known in the art for the manufacture of aromatic sulfone polymers. Typically, a PFPE oligomer (OL_{P1}) or (OL-BB) is mixed with the selected monomers (A) and (B) in the presence of a solvent, preferably N-methyl-2-pirrolidone (NMP), dimethyl sulfoxide (DMSO), N,N′-dimethyl acetamide (DMAc) or sulfolane, and of an inorganic base, typically a carbonate, preferably Na₂CO₃ or K₂CO₃ and reacted under heating at a temperature ranging from 200° C. to 230° C. A (F-PS) having hydroxyl terminal groups is obtained when a higher amount of monomer (B) than that of monomer (A) is used, while a (F-PS) having halogen terminal groups is obtained when a higher amount of monomer (A) than that of monomer (B) is used. In steps (b_{P1}) and (b_{P2}), monomer (A) is preferably 4,4′-difluorodiphenylsulfone, while monomer (B) is preferably 4,4′-dihydroxydiphenylsulfone or 4,4′-dihydroxy diphenyl.

Steps (b′_{P1}) and (b′_{P2}) are typically carried out by reacting a PFPE oligomer (OL_{P1}) or (OL-BB) and a polymer (r-PS) in an appropriate solvent, preferably NMP, DMSO, DMAc or sulfolane, in the presence of an inorganic base, typically a carbonate, preferably Na₂CO₃ or K₂CO₃, and heating at a temperature ranging from 200° C. to 230° C.

The (r-PS) has a molecular weight usually ranging from 9,000 to 12,000 Da and will be selected in such a way that the ratio between the molecular weight of the PFPE oligomer (OL_{P1}) or (OL-BB) and the polymer (r-PS) provides a (F-PS) having a fluorine content ranging from 0.1% 10% wt.

Preferred examples of (r-PS) include include poly(phenylene sulfone) polymers [polymers (PPSU)], poly(sulfone) polymers [polymers (PSU)] and poly(ether sulfone) polymers [polymers (PESU)].

Non limiting examples of polymers (r-PPSU) suitable for the present invention include those commercially available under the trademark names RADEL® from Solvay Specialty Polymers USA L.L.C.

Non-limiting examples of polymers (r-PSU) suitable for the invention include those commercially available under the trademark name UDEL® from Solvay Specialty Polymers USA L.L.C.

Non-limiting examples of polymers (r-PESU) suitable for the invention include those commercially available under the trademark name VERADEL® from Solvay Specialty Polymers USA L.L.C. A convenient example of (r-PESU) is a hydroxyl-terminated polyethersulfone obtained by polycondensation of 4,4′-dichlorodiphenylsulfone and 4,4′-dihydroxydiphenylsulfone.

Preferred processes (P1) and (P2), which comprise the preliminary attachment by ethereal linkage of one or two of monomers (A) and/or (B) or sulfonic ester thereof to the at least one hydroxyl group at one of both ends of the PFPE alcohol, are particularly advantageous for the manufacture of (F-PS) incorporating at least one unit derived from PFPE alcohols having at least one —CF₂CH₂OH or —CF(CF₃)CH₂OH terminal group. Without being bound to theory, it is believed that processes (P1) and (P2) are advantageous in that the conversion of a PFPE alcohol into an PFPE oligomer (OL_{P1}) or (OL-BB) increases the reactivity of the PFPE alcohol towards monomers (A) and (B) in the copolymerization reaction of step (b_{P1})/(b_{P2}) or towards a reactive polymer (r-PS) in step (b′_{P1})/(b′_{P2}). It has indeed been observed that when PFPE alcohols (PFPE-1) comprising —CF₂CH₂OH or —CF(CF₃)CH₂OH terminal groups are directly submitted to copolymerization with monomers (A) and (B) or to reaction with polymer (r-PS), it is difficult to obtain the desired (F-PS), probably due to the electron-withdrawing effect of the —CF₂— or —C(CF₃)— moiety in the —CF₂CH₂OH or —CF(CF₃)CH₂OH groups, which makes the oxygen atom less nucleophilic. Therefore the present invention provides convenient processes, processes (P1) and (P2), for the manufacture of (F-PS) incorporating at least one unit derived from PFPE alcohols having at least one —CF₂CH₂OH or —CF(CF₃)CH₂OH terminal group.

### Compositions (C)

As stated above, the present invention relates to compositions comprising polymer (F-PS) [compositions (C)] for the manufacture of films (F) and membranes (M). Polymer (F-PS) can be the sole polymer in compositions (C) or can be used in admixture with one of more further polymers, preferably with non-fluorinated aromatic sulfone polymers.

Thus, compositions (C) according to the invention comprise:
at least one polymer (F-PS);
optionally, at least one polymer different from (F-PS), preferably a non-fluorinated aromatic sulfone polymer [polymer (PS)];
at least one ingredient independently selected from: a liquid medium comprising at least one organic solvent [medium (L)], a pore-forming agent, a filler, a salt, a latent organic solvent, surfactant.

According to a preferred embodiment, composition (C) is free of plasticizing agents, i.e. either plasticizing agents are not added to composition (C) or they are present in an amount of less than 1 wt. %, more preferably less than 0.1 wt. % based on the total weight of said composition (C).

Preferably, composition (C) comprises at least polymer (F-PS) in an amount of from 10 to 100 wt. % based on the total weight of composition (C).

Preferably, composition (C) comprises at least one sulfone polymer (PS) in an amount of from 0.1 to 80 wt. % based on the total weight of said composition (C).

As intended herein, a non-fluorinated aromatic sulfone polymer [polymer (PS)] is intended to denote an aromatic sulfone polymer that does not comprise units deriving from a PFPE alcohol as defined above.

Preferably, polymer (PS) comprises recurring units derived from at least one monomer (A) and recurring units derived from at least one monomer (B) as defined above; recurring units (A) and/or (B) can be equal to or different from those of (F-PS) Polymer (PS) can be a reactive polymer (r-PS) as defined above or a commercially available (PS) comprising end capping alkyl groups.

Preferably, composition (C) comprises at least one further ingredient, more preferably said at least one further ingredient is in an amount of from 0.1 to 30 wt. % based on the total weight of said composition (C).

The term “solvent” is used herein in its usual meaning, that is it indicates a substance capable of dissolving another substance (solute) to form an uniformly dispersed mixture at molecular level. In the case of a polymeric solute, it is common practice to refer to a solution of the polymer in a solvent when the resulting mixture is transparent and no phase separation is visible in the system. Phase separation is taken to be the point, often referred to as “cloud point”, at which the solution becomes turbid or cloudy due to the formation of polymer aggregates.

The at least one organic solvent is preferably selected from the group comprising:
aliphatic hydrocarbons including, more particularly, the paraffins such as, in particular, pentane, hexane, heptane, octane, nonane, decane, undecane, dodecane or cyclohexane, and naphthalene and aromatic hydrocarbons and more particularly aromatic hydrocarbons such as, in particular, benzene, toluene, xylenes, cumene, petroleum fractions composed of a mixture of alkylbenzenes;
aliphatic or aromatic halogenated hydrocarbons including more particularly, perchlorinated hydrocarbons such as, in particular, tetrachloroethylene, hexachloroethane;
partially chlorinated hydrocarbons such as dichloromethane, chloroform, 1,2-dichloroethane, 1,1,1-trichloroethane, 1,1,2,2-tetrachloroethane, pentachloroethane, trichloroethylene, 1-chlorobutane, 1,2-dichlorobutane, monochlorobenzene, 1,2-dichlorobenzene, 1,3-dichlorobenzene, 1,4-dichlorobenzene, 1,2,4-trichlorobenzene or mixture of different chlorobenzenes;
aliphatic, cycloaliphatic or aromatic ether oxides, more particularly, diethyl oxide, dipropyl oxide, diisopropyl oxide, dibutyl oxide, methylterbutyl ether, dipentyl oxide, diisopentyl oxide, ethylene glycol dimethyl ether, ethylene glycol diethyl ether, ethylene glycol dibutyl ether benzyl oxide; dioxane, tetrahydrofuran (THF);
dimethylsulfoxide (DMSO);
glycol ethers such as ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether;
glycol ether esters such as ethylene glycol methyl ether acetate, ethylene glycol monoethyl ether acetate, ethylene glycol monobutyl ether acetate;
alcohols, including polyhydric alcohols, such as methyl alcohol, ethyl alcohol, diacetone alcohol, ethylene glycol;
ketones such as acetone, methylethylketone, methylisobutyl ketone, diisobutylketone, cyclohexanone, isophorone;
linear or cyclic esters such as isopropyl acetate, n-butyl acetate, methyl acetoacetate, dimethyl phthalate, γ-butyrolactone;
linear or cyclic carboxamides such as N,N-dimethylacetamide (DMAc), N,N-diethylacetamide, dimethylformamide (DMF), diethylformamide or N-methyl-2-pyrrolidone (NMP);
organic carbonates for example dimethyl carbonate, diethyl carbonate, dipropyl carbonate, dibutyl carbonate, ethylmethyl carbonate, ethylene carbonate, vinylene carbonate;
phosphoric esters such as trimethyl phosphate, triethyl phosphate (TEP);
ureas such as tetramethylurea, tetraethylurea;
methyl-5-dimethylamino-2-methyl-5-oxopentanoate (commercially available under the tradename Rhodialsov Polarclean®).

The following are particularly preferred: NMP, DMAc, DMF, dimethylsulfoxide (DMSO), THF, methyl-5-dimethylamino-2-methyl-5-oxopentanoate and TEP.

Medium (L) preferably comprises at least 40 wt. %, more preferably at least 50 wt. % based on the total weight of said medium (L), of at least one organic solvent. Medium (L) preferably comprises at most 100 wt. %, more preferably at most 99 wt. % based on the total weight of said medium (L), of at least one organic solvent.

Medium (L) preferably comprises at least 40 wt. %, more preferably at least 50 wt. % based on the total weight of said medium (L), of at least one organic solvent. Medium (L) preferably comprises at most 100 wt. %, more preferably at most 99 wt. % based on the total weight of said medium (L), of at least one organic solvent.

Medium (L) may further comprise at least one non-solvent medium [medium (NS)]. The medium (NS) may comprise water and, optionally, at least one organic solvent selected from alcohols or polyalcohols, preferably aliphatic alcohols having a short chain, for example from 1 to 6 carbon atoms, more preferably methanol, ethanol, isopropanol and ethylene glycol.

Medium (NS) is generally selected among those miscible with the medium (L) used for the preparation of composition (C^{L}). More preferably, medium (NS) consists of water, as it is the most inexpensive non-solvent medium and can be used in large amounts.

Pore forming agents are preferably polyvinyl-pyrrolidone (PVP) and polyethyleneglycol (PEG), PVP being preferred.

As used herein, the term “latent” is intended to denote an organic solvent which behaves as an active solvent only when heated above a certain temperature.

Composition (C) according to the present invention can be in the form of a liquid composition [composition (C^{L})] or in the form of a solid composition [composition (C^{S})].

Composition (C^{L}) preferably comprises at least one medium (L) in an amount of at least 5 wt. %, more preferably of at least 7 wt. % based on the total weight of composition (C^{L}).

Composition (C^{L}) preferably comprises at least one medium (L) in an amount of at most 95 wt. %, more preferably of at most 90 wt. % based on the total weight of composition (C^{L}).

Even more preferably, composition (C^{L}) comprises at least one medium (L) in an amount from 20 to 90 wt. % based on the total weight of composition (C^{L}).

Further, in addition, a limited amount of a medium (NS) for the F-TPU polymer may be added to composition (C^{L}), in an amount generally below the level required to reach the cloud point, typically in amount of from 0.1% to 40% wt, preferably in an amount of from 0.1% to 20% wt, based on the total weight of composition (C^{L}).

Without being bound to theory, it is understood that the addition of a medium (NS) to composition (C^{L}) increases the rate of demixing/coagulation when a membrane (M) is manufactured by a phase-inversion method, providing a more advantageous membrane morphology.

Composition (C^{L}) can optionally comprise at least one further ingredient, selected from those listed above for composition (C), in the same amounts.

Composition (C^{S}) preferably comprises at least one polymer (F-PS) in an amount of at most 50% wt, preferably of at most 35% wt, based on the total weight of composition (C^{S}).

Even more preferably, composition (C^{S}) comprises at least one polymer (F-PS) in an amount from 3% to 30% wt based on the total weight of composition (C^{S}).

Composition (C^{S}) preferably comprises at least one polymer (PS) in an amount of at least 50% wt, preferably of at least 65% wt, based on the total weight of composition (C^{S}).

Even more preferably, composition (C^{S}) comprises at least one polymer (PS) in an amount from 70% to 97% wt based on the total weight of composition (C^{S}).

Compositions (C^{L}) are used in methods for the manufacture of films (F) and membranes (M) comprising a precipitation step of polymer (F-PS) from a solution, namely in phase-inversion methods.

Compositions (C^{S}) are used in processes for the manufacture of films (F) and membranes (M) that are carried out in a solid phase, typically in molten phase.

### Film (F) and Membrane (M)

Film (F) according to the present invention is advantageously a dense film. Film (M) is usually processed into a membrane (M). Depending on the final form of membrane (M), film (M) may be either flat, when flat membranes are required, or tubular in shape, when tubular or hollow-fiber membranes are required.

Membrane (F) according to the present invention is a porous membranes. Membranes containing pores homogeneously distributed throughout their thickness are generally known as symmetric (or isotropic) membranes; membranes containing pores which are heterogeneously distributed throughout their thickness are generally known as asymmetric (or anisotropic) membranes.

The porous membrane according to the present invention may be either a symmetric membrane or an asymmetric membrane.

The asymmetric porous membrane typically consists of one or more layers containing pores which are heterogeneously distributed throughout their thickness.

The asymmetric porous membrane typically comprises an outer layer containing pores having an average pore diameter smaller than the average pore diameter of the pores in one or more inner layers.

The porous membrane of the invention preferably has an average pore diameter of at least 0.001 μm, more preferably of at least 0.005 μm, and even more preferably of at least 0.01 μm. The porous membrane of the invention preferably has an average pore diameter of at most 50 μm, more preferably of at most 20 μm and even more preferably of at most 15 μm.

Suitable techniques for the determination of the average pore diameter in the porous membranes of the invention are described for instance in Handbook of Industrial Membrane Technology. Edited by PORTER. Mark C. Noyes Publications, 1990. p. 70-78. Average pore diameter is preferably determined by scanning electron microscopy (SEM).

The porous membrane of the invention typically has a gravimetric porosity comprised between 5% and 90%, preferably between 10% and 85% by volume, more preferably between 30% and 90%, based on the total volume of the membrane.

For the purpose of the present invention, the term “gravimetric porosity” is intended to denote the fraction of voids over the total volume of the porous membrane.

Suitable techniques for the determination of the gravimetric porosity in the porous membranes of the invention are described for instance in SMOLDERS K., et al. Terminology for membrane distillation. Desalination. 1989, vol. 72, p. 249-262.

The porous membrane of the invention may be either a self-standing porous membrane or a porous membrane supported onto a substrate.

A porous membrane supported onto a substrate is typically obtainable by coating said substrate with said porous membrane or by impregnating or dipping said substrate with said composition (C) as defined above.

The porous membrane of the invention may further comprise at least one substrate layer. The substrate layer may be partially or fully interpenetrated by the porous membrane of the invention.

The nature of the substrate is not particularly limited. The substrate generally consists of materials having a minimal influence on the selectivity of the porous membrane. The substrate layer preferably consists of non-woven materials, glass fibers and/or polymeric material such as for example polypropylene, polyethylene and polyethyleneterephthalate.

The porous membrane of the invention may be a porous composite membrane comprising:
at least one substrate layer, preferably a non-woven substrate,
at least one top layer, and
between said at least one substrate layer and said at least one top layer, at least one layer consisting of a composition (C) as defined above.

Typical examples of such porous composite membranes are the so called Thin Film Composite (TFC) structures which are typically used in reverse osmosis or nanofiltration applications.

Non limiting examples of top layers suitable for use in the porous composite membrane of the invention include those made of polymers selected from the group consisting of polyamides, polyimides, polyacrylonitriles, polybenzimidazoles, cellulose acetates and polyolefins.

### Methods for the Manufacture of Film (F) and Membrane (M)

Films (F) and membrane (M) can be manufactured according to conventional methods, such as phase-inversion methods and methods occurring in the molten phase.

Usually, for the manufacture of a film (F) and membrane (M), a composition (C) is manufactured by a conventional method, processed into a film (F) and, optionally film (M), is further processed into a membrane (M).

According to a first embodiment, film (F) and membrane (M) are manufactured by means of a process occurring in the liquid phase [process (MP-1)], which typically comprises: (i\hat{ }) providing a liquid composition [composition (C^{L})] comprising:
at least one polymer (F-PS) as defined above,
a liquid medium comprising at least one organic solvent [medium (L)];

(ii\hat{ }) processing composition (C^{L}) provided in step (i\hat{ }) thereby providing a film (F); and optionally,

(iii\hat{ }) precipitating film (F) obtained in step (ii\hat{ }) thereby providing a membrane (M).

Under step (i\hat{ }), composition (C^{L}) is manufactured by any conventional techniques. For instance, medium (L) can be added to polymer (F-PS) and, optionally, to polymer (PS) and to any further ingredient, or, preferably, polymer (F-PS) and, optionally, polymer (PS) and any further ingredient are added to medium (L); alternatively, polymer (F-PS) and, optionally, polymer (PS), any further ingredient and medium (L) are simultaneously mixed.

Any suitable mixing equipment may be used. Preferably, the mixing equipment is selected to reduce the amount of air entrapped in composition (C^{L}) which may cause defects in the final membrane. Mixing is conveniently carried out in a sealed container, optionally kept under an inert atmosphere. Inert atmosphere, and more precisely nitrogen atmosphere has been found particularly advantageous for the manufacture of composition (C^{L}).

Under step (i\hat{ }), the mixing time during stirring required to obtain a clear homogeneous composition (C^{L}) can vary widely depending upon the rate of dissolution of the components, the temperature, the efficiency of the mixing apparatus, the viscosity of composition (C^{L}) and the like.

Under step (ii\hat{ }), composition (C^{L}) is typically processed in the liquid phase.

Under step (ii\hat{ }), composition (C^{L}) is typically processed by casting, thereby providing a film (F).

Casting generally involves solution casting, wherein typically a casting knife, a draw-down bar or a slot die is used to spread an even film of a liquid composition comprising a suitable medium (L) across a suitable support.

Under step (ii\hat{ }), the temperature at which composition (C^{L}) is processed by casting may or may not be the same as the temperature at which composition (C^{L}) is mixed under stirring.

Different casting techniques are used depending on the final form of membrane (M).

When membrane (M) is a flat membrane, composition (C^{L}) is cast as a film (F) over a flat supporting substrate, typically a plate, a belt or a fabric, or another microporous supporting membrane, typically by means of a casting knife, a draw-down bar or a slot die.

According to a first embodiment of step (ii\hat{ }), composition (C^{L}) is processed by casting onto a flat supporting substrate to provide a flat film (F).

According to a second embodiment of step (ii\hat{ }), composition (C^{L}) is processed by casting to provide a tubular film (F).

According to a variant of this second embodiment of the invention, the tubular film (F) is manufactured using a spinneret.

The term “spinneret” is hereby understood to mean an annular nozzle comprising at least two concentric capillaries: a first outer capillary for the passage of composition (C^{L}) and a second inner one for the passage of a supporting fluid, generally referred to as “lumen”. Optionally, an external outer capillary can be used to extrude a coating layer.

Hollow fibers and capillary membranes can be manufactured by a so-called “spinning process” according to this variant of the second embodiment of step (ii\hat{ }). According to this variant, composition (C^{L}) is generally pumped through the spinneret; the lumen acts as support for the casting of the composition (C^{L}) and maintains the bore of the hollow fiber or capillary precursor open. The lumen can be a gas, or, preferably, a medium (NS) or a mixture of a medium (NS) with a medium (L). The selection of the lumen and its temperature depends on the required characteristics of the final membrane as they may have a significant effect on the size and distribution of the pores in the membrane.

At the exit of the spinneret, after a short residence time in air or in a controlled atmosphere, under step (iii\hat{ }) of (MP-1), the hollow fiber or capillary precursor is precipitated, thereby providing a hollow fiber or capillary membrane (M).

The supporting fluid forms the bore of the final hollow fiber or capillary membrane (M).

Because of their larger diameter, tubular membranes are generally manufactured using a different process from the one employed for the production of hollow fiber membranes.

The temperature gradient between the film provided in any one of steps (ii\hat{ }) and (iii\hat{ }) of process (MP-1) and medium (NS) shall be selected by a person skilled in the art in such a way as to adjust the rate of precipitation of polymer (F-PS) from composition (C^{L}) and obtained the desired pore size and/or pore distribution in the final porous membrane.

Thus, a first variant of process (MP-1) comprises: (i\hat{ }*) providing a liquid composition [composition (C^{L})] comprising:
at least one polymer (F-PS) and
a liquid medium comprising at least one organic solvent [medium (L)];

(ii\hat{ }*) processing composition (C^{L}) provided in step (i\hat{ }*) thereby providing a film; and optionally

(iii\hat{ }*) precipitating the film provided in step (ii\hat{ }*) in a non-solvent medium [medium (NS)], thereby providing a membrane (M).

A further variant of [process (MP-1)] comprises: (i\hat{ }**) providing a liquid composition [composition (C^{L})] comprising:
at least one polymer (F-PS) and
a liquid medium comprising at least one organic solvent [medium (L)];

(ii\hat{ }**) processing composition (C^{L}) provided in step (i\hat{ }**) thereby providing a film; and optionally

(iii\hat{ }**) precipitating the film provided in step (ii\hat{ }**) by cooling thereby providing a porous membrane.

Under step (ii\hat{ }**), the film is typically processed at a temperature high enough to maintain composition (C^{L}) as a homogeneous solution.

Under step (ii\hat{ }**), the film is typically processed at a temperature comprised between 60° C. and 250° C., preferably between 70° C. and 220°, more preferably between 80° C. and 200° C.

Under step (iii\hat{ }**), the film provided in step (ii\hat{ }**) is typically precipitated by cooling to a temperature below 100° C., preferably below 60° C., more preferably below 40° C., typically using any conventional techniques.

Under step (iii\hat{ }**), cooling is typically carried out by contacting the film provided in step (ii) with a liquid medium [medium (L′)].

Under step (iii\hat{ }**), the medium (L′) preferably comprises, and more preferably consists of, water.

Alternatively, under step (iii\hat{ }**), cooling is carried out by contacting the film provided in step (ii\hat{ }**) with air.

Under step (iii\hat{ }**), either the medium (L′) or air is typically maintained at a temperature below 100° C., preferably below 60° C., more preferably below 40° C.

A further variant of process (MP-1) comprises: (i\hat{ }***) providing a liquid composition [composition (C^{L})] comprising:
at least one polymer (F-PS), and
a liquid medium comprising at least one organic solvent [medium (L)];

(ii\hat{ }***) processing composition (C^{L}) provided in step (i\hat{ }***) thereby providing a film (F); and optionally

(iii\hat{ }***) precipitating film (F) provided in step (ii\hat{ }***) by absorption of a non-solvent medium [medium (NS)] from a vapour phase thereby providing a porous membrane (M).

Under step (iii\hat{ }***), film (F) provided in step (ii\hat{ }***) is preferably precipitated by absorption of water from a water vapour phase.

Under step (iii\hat{ }***), film (F) provided in step (ii\hat{ }***) is preferably precipitated under air, typically having a relative humidity higher than 10%, preferably higher than 50%.

A variant of [process (MP-1)] comprises: (i\hat{ }****) providing a liquid composition [composition (C^{L})] comprising:
at least one polymer (F-PS) and
a liquid medium comprising at least one organic solvent [medium (L)];

(ii\hat{ }****) processing composition (C^{L}) provided in step (i\hat{ }****) thereby providing a film (F); and optionally

(iii\hat{ }****) precipitating the film provided in step (ii\hat{ }****) by evaporation of medium (L) thereby providing a porous membrane (M).

Preferably, when medium (L) comprise more than one organic solvents, step (ii\hat{ }****) comprises processing composition (C^{L}) to provide a film, which is then precipitated in step (iii\hat{ }****) by evaporation of medium (L) at a temperature above the boiling point of the organic solvent having the lowest boiling point.

According to a preferred embodiment, step (ii\hat{ }****) is performed by processing composition (C^{L}) with a high voltage electric field.

A process (MP-1) may consist in one or more of the variants described herein before.

Membrane (M) obtainable by process (MP-1) may undergo additional post treatment steps, for instance rinsing and/or stretching.

Membrane (M) obtainable by the process (MP-1) is typically rinsed using a liquid medium miscible with the medium (L).

Membrane (M) obtainable by (MP-1) may be advantageously stretched so as to increase its average porosity.

According to a second embodiment, film (F) and membrane (M) are manufactured by means of a process occurring in the solid phase [process (MP-2)], which typically comprises:

(i\hat{ }\hat{ }) providing a solid composition [composition (C^{S})] comprising:
at least one polymer (F-PS) and

(ii\hat{ }\hat{ }A) processing the composition (C^{S}) provided in step (i\hat{ }\hat{ }) thereby providing a film (F) and,

optionally (iii\hat{ }\hat{ }A) stretching film (F) provided in step (ii\hat{ }\hat{ }A);

or

(ii\hat{ }\hat{ }B) processing the composition (C^{S}) provided in step (i\hat{ }\hat{ }) thereby providing fibers and,

optionally (iii\hat{ }\hat{ }B) processing the fibers provided in (ii\hat{ }\hat{ }B) thereby providing a membrane (M).

Under step (ii\hat{ }\hat{ }A), composition (C^{S}) is preferably processed in molten phase.

Melt forming is commonly used to make dense films by film extrusion, preferably by flat cast film extrusion or by blown film extrusion.

According to this technique, composition (C^{S}) is extruded through a die so as to obtain a molten tape, which is then calibrated and stretched in the two directions until obtaining the required thickness and wideness. Composition (C^{S}) is melt compounded for obtaining a molten composition. Generally, melt compounding is carried out in an extruder. Composition (C^{S}) is typically extruded through a die at temperatures of generally lower than 250° C., preferably lower than 200° C. thereby providing strands which are typically cut thereby providing pellets.

Twin screw extruders are preferred devices for accomplishing melt compounding of composition (C^{S}).

Films (F) can then be manufactured by processing the pellets so obtained through traditional film extrusion techniques. Film extrusion is preferably accomplished through a flat cast film extrusion process or a hot blown film extrusion process. Film extrusion is more preferably accomplished by a hot blown film extrusion process.

Under step (iii\hat{ }\hat{ }A), the film provided in step (ii\hat{ }\hat{ }A) may be stretched either in molten phase or after its solidification upon cooling.

Under step (iii\hat{ }\hat{ }A), the film provided in step (ii\hat{ }\hat{ }A) is advantageously stretched at right angle to the original orientation, so that the crystalline structure of the polymer (A) is typically deformed and slit-like voids are advantageously formed.

The porous membrane obtainable by the process of the invention is typically dried, preferably at a temperature of at least 30° C.

Drying can be performed under air or a modified atmosphere, e.g. under an inert gas, typically exempt from moisture (water vapour content of less than 0.001% v/v). Drying can alternatively be performed under vacuum.

The porous membrane of the invention may be in the form of flat membranes or in the form of tubular membranes.

Flat membranes are generally preferred when high fluxes are required whereas hollow fibers membranes are particularly advantageous in applications wherein compact modules having high surface areas are required.

Flat membranes preferably have a thickness comprised between 10 μm and 200 μm, more preferably between 15 μm and 150 μm.

Tubular membranes typically have an outer diameter greater than 3 mm. Tubular membranes having an outer diameter comprised between 0.5 mm and 3 mm are typically referred to as hollow fibers membranes. Tubular membranes having a diameter of less than 0.5 mm are typically referred to as capillary membranes.

### Industrial Applications of Film (F) and Membrane (M)

Films (F) and membranes (M) according to the present invention can be used in several technical fields, notably for the filtration of liquid and/or gas phases.

Thus, in one aspect, the present invention relates to the use of membrane (M) for the filtration of liquid and/or gas phases comprising one or more solid contaminants.

In another aspect, the present invention relates to a method for filtering a liquid phase and/or a gas phase comprising one or more solid contaminants, said method comprising contacting said liquid phase and/or gas phase comprising one or more solid contaminants with membrane (M) of the invention.

Liquid and gas phases comprising one or more solid contaminants are also referred to as “suspensions”, i.e. heterogeneous mixtures comprising at least one solid particle (the contaminant) dispersed into a continuous phase (or “dispersion medium”, which is in the form of liquid or gas).

Said at least one solid contaminant preferably comprises microorganisms, preferably selected from the group consisting of bacteria such as Staphylococcus aureus and Pseudomonas aeruginosa, algae, fungi, protozoa and viruses.

Membrane (M) can be used for filtrating biologic solution (e.g. bioburden, virus, other large molecules) and/or buffer solutions (e.g. solutions that may contain small amount of solvents like DMSO or other polar aprotic solvents).

In one embodiment, two or more porous membranes (M) can be used in series for the filtration of a liquid and/or gas phase. Advantageously, a first filtration step is performed by contacting liquid and/or gas phases comprising one or more solid contaminants with a membrane (M) according to the present invention having an average pore diameter higher than 5 μm, more preferably from 5 to 50 μm; and a second filtration step is performed after said first filtration step, by contacting the same liquid and/or gas phase with a membrane (M) having an average pore diameter of from 0.001 to 5 μm.

Alternatively, at least one membrane (M) is used in series with at least one porous membrane obtained from a composition different composition (C) according to the present invention.

According a specific and further embodiment of the invention, membranes (M) in the form of tubular or hollow fibers and having average pore diameter of from 0.001 to 5 μm are used within an extracorporeal blood circuit or a dialysis filter to purify biological fluids, namely blood. It has indeed been observed that, membranes (M) according to the present invention are antithrombogenic; in particular, it has been observed that membranes (M) comprising polymers (F-PU) of the present invention have a higher antithrombogenic effect than membranes comprising a corresponding unmodified aromatic sulfone polymer.

As used herein, the term “antithrombogenic” means that the rate at which thrombosis occurs when whole blood is contacted with a membrane (M) is lower than that when whole blood is contacted with a membrane prepared starting from a composition free from the at least one polymer (F-PS). It is well known in the art, for example from US 2015/0008179 (INTERFACE BIOLOGICS INC.), that when blood is transported to and from the body of patients receiving haemodialysis, anticoagulants such as heparin are typically added to prevent clotting or thrombosis. However, if on the one hand the use of heparin is advantageous, it can be complicated by allergic reactions and bleeding and, in addition, it is contraindicated in patients taking certain medications.

Thus, in a further aspect, the present invention relates to the use of a hollow fiber membrane having an average pore diameter of from 0.001 to 5 μm as component in an extracorporeal blood circuit or in a dialysis filter.

In a further aspect, the present invention relates to a method for treating a subject suffering from impaired kidney function, the method comprising subjecting a patient to a procedure selected from haemodialysis, hemofiltration, hemoconcentration or hemodiafiltration, said procedure being carried out with a dialysis filter comprising at least one membrane (M) in the form of tubular or hollow fiber having an average pore diameter of from 0.001 to 5 μm.

In a further aspect, the present invention relates to a method for purifying a blood product, such as whole blood, plasma, fractionated blood component or mixtures thereof, wherein the method includes dialyzing said blood product across at least one hollow fiber membrane having an average pore diameter of from 0.001 to 5 μm and comprising at least one layer consisting of a composition [composition (C)] as defined above.

Film (F) according to the present invention is also advantageously used for the manufacture of tubes, notably for use in medicine, such as for example catheters and implantable devices. Thus, in a further aspect, the present invention relates to a catheter comprising at least one layer made from film (F).

The invention will be herein after illustrated in greater detail by means of the Examples contained in the following Experimental Section; the Examples are merely illustrative and are by no means to be interpreted as limitative of the scope of the invention.

### EXPERIMENTAL SECTION

### Materials and Methods

### Materials

The following solvents were obtained from Sigma-Aldrich: N-methyl-2-pirolidone (NMP), dimethyl acetamide (DMAc) and isopropyl alcohol (IPA).

The following PFPE alcohols were used:

1) PFPE alcohol (I-A), complying with formula:

HOCH₂CF₂(OCF₂CF₂)ₐ₁(OCF₂)ₐ₂OCF₂CH₂OH

wherein: a1/a2=1.5 and a1+a2 is selected in such a way that Mn=1580 and EW=863

Average —OH functionality (F_{OH})=1.83

PFPE alcohol (I-A) is commercially available from Solvay Specialty

Polymers Italy S.p.A. as Fomblin® D2.

2) PFPE alcohol (I-B), complying with formula:

HO(CH₂CH₂O)ₙCH₂CF₂(OCF₂CF₂)ₐ₁(OCF₂)ₐ₂OCF₂CH₂(OCH₂CH₂)ₙOH

wherein: a1/a2=1.5 and a1+a2 is selected in such a way that Mn=1740 and Ew=950; n=1.8

Average —OH functionality (F_{OH})=1.83

PFPE alcohol (I-B) is commercially available from Solvay Specialty

Polymers Italy S.p.A. as Fomblin® E-10H.

3) PFPE alcohol (I-C), complying with formula:

HO(CH₂CH₂O)ₙCH₂CF₂(OCF₂CF₂)ₐ₁(OCF₂)ₐ₂OCF₂CH₂(OCH₂CH₂)ₙOH

wherein: a1/a2=1.5 and a1+a2 is selected in such a way that Mn=1670 and E_{W}=912; n=1

Average —OH functionality (F_{OH})=1.83

PFPE alcohol (I-C) was manufactured according to a known procedure by reacting a commercially available PFPE alcohol having —CF₂CH₂OH end groups (Fluorolink® D2 PFPE) with ethylenecarbonate in the presence of a catalytic amount of tert-BuOK. The reaction was carried out under neat conditions at 120-130° C. The crude product was worked up by alkaline hydrolysis of the residual carbonate groups, followed by acidification and washing with water until neutrality. The target product PFPE alcohol (I-C) was obtained with a 95% yield.

4) PFPE alcohol (I-D), complying with formula:

CF₃(OCF₂CF₂)ₐ₁(OCF₂)ₐ₂OCF₂CH₂OH

wherein: a1/a2=1.5 and a1+a2 is selected in such a way that Ew=655

Average —OH functionality (F_{OH})=1.0

PFPE alcohol (I-D) was manufactured according to the teaching of U.S. Pat. No. 6,127,498 (AUSIMONT S.P.A.)

Veradel® 3300 PESU was obtained from Solvay Specialty Polymers.

The polyethersulfone with hydroxyl end groups (r-PESU) referred to in Examples 18-21 was synthesised as follows. In a 1000 ml four-neck reaction kettle equipped with a magnetic stirrer and N₂ inlet, 127.25 g (0.509 mol) of 4,4′-dixydroxydiphenylsulfone (DHDPS) and 143.5 g (0.5 mol) of dichlorodiphenylsulfone (DCDPS) were charged together with 250 mL sulfolane. The mixture was heated to 100° C. with stirring under N₂ flow until DHDPS and DCDPS were dissolved completely.

Thereafter, a mixture of K₂CO₃ and Na₂CO₃ (0.99:0.15) was slowly added to the reaction mixture followed addition of about 250 mL sulfolane. Then, the inner temperature was slowly increased to 218° C. and the reaction was continued for about 5.5 h. No significant change in the molecular weight was observed after this reaction time. The increase of molecular weight was monitored by online GPC [final Mw about 32,000; polydispersity index (PDI)=3]. After completion of the reaction, the resulting viscous polymer solution was filtered by a pressure filtration process under hot conditions to remove any unreacted salts. Thereafter, the resulting viscous polymer solution was slowly poured into an excess of deionized (DI) water under constant stirring. The precipitated polymer powder was collected by filtration and washed thoroughly with DI water followed by hot DI water to remove any residual solvent. After final washing, the residual amount of solvent (% RS, w/w) value determined by GC was found as 0.2. Finally, the (r-PESU) powder was collected after drying overnight at 120° C. in an oven. Yield: about 99%.

### Methods

### NMR Analyses

¹⁹F-NMR spectra were recorded on a Bruker AV 400 MHz spectrometer using (DMSO-d6+C₆F₆) as solvent. A pulse delay of 5 s was applied during the NMR measurement to ensure complete T1 relaxation for quantitative analysis.

### Gel Permeation Chromatography of the (F-PS) of the Invention

Polymer samples were completely dissolved in dichloromethane at a concentration of about 1000 ppm. Any fillers or insoluble additives were removed by filtration through a 0.2 micron PTFE disposable syringe filter. The filtered polymer solution was separated on a SEC system consisting of a Jasco HPLC pump (model no. PU-2080 plus), Jasco® UV detector (model no. UV-2075 plus) at 254 nm. The temperature was maintained at 25+/−1° C. during the analysis, which was performed on a set of two MIXED D SEC columns and MIXED D guard column (from Agilent®). Injection volume: 20 microliters. Clarity SEC integration software (Version 5.0.00.323). Mobile phase: dichloromethane at a flow rate of 1.5 mL/minute. The system was calibrated using a set of polystyrene standard samples. Molecular weights were calculated using a calibration file generated using polystyrene standards by means of the SEC integration software.

### Gel Permeation Chromatography of PFPE Alcohol and PFPE Oligomers

PFPE oligomers were completely dissolved in hexafluoro xylene:isopropyl alcohol (80:20 v/v ratio) at a concentration of about 20000 ppm. Any fillers or insoluble additives were removed by filtration through 0.2 micron PTFE disposable syringe filters. The filtered solution was separated on a SEC system consisting of a Waters-S1S pump, Shodex-RI-101-detector. The temperature was maintained at 35+/−1° C. during the analysis, which was performed on a set of three-PLgel columns having individual pore size 1000 Å, 100 Å and 50 Å in series with guard column (from Agilent®). Injection volume: 200 microliters. Clarity SEC integration software (Version 5.0.00.323). The mobile phase was hexafluoroxylene:IPA (70:30 v/v ratio) at a flow rate of 1.0 mL/minute. The system was calibrated using a set of narrow molecular weight distribution of PFPE alcohol standard (Mw ranging from 600 to 3000).

### Analysis of Halogen End Groups

The end group analysis was carried out by titration (Metrohm® auto titrator with pH electrode). Ionic F⁻ or Cl⁻ (i.e. fluoride or chloride ions) was detected by ion chromatography (IC) using a METROHM COMBUSTION IC instrument. The samples to analyze were dissolved and diluted according to the instructions provided by the instrument manufacturer, then fluoride concentration of was estimated according to the following formulae:
concentration of F⁻ in absorption solution (ppm)=concentration of F⁻ in diluted solution from calibration curve (ppm)×dilution factor (ppm)
concentration of F⁻ in sample (%)={Concentration of F⁻ in absorption solution (ppm)×final volume of absorber solution (mL)/wt of sample (μg)}×100
wherein:
   absorption solution denotes the solution to be analysed for F— ion detection;
   diluted solution denotes a solution obtained from the absorption solution by dilution in the detection range of the instrument to get accurate value and
   absorber solution denotes a scrubbing solution (500 ppm H₂O₂ in water) for F— ion.

### Analysis of Hydroxy (—OH) End Groups

For hydroxyl (—OH) end group analysis, the samples to be analysed were dissolved in dichloromethane and titrated with 0.02 N tetrabutylammonium hydroxide solution in toluene. The hydroxyl value was calculated from the following formulae:

—OH value (in μeq/gm)=(EP×N×1000)/sample wt. (g)

where EP is the end point of the titration and N is normality of the titrant solution.

### Determination of the Fluorine Content in the (F-PS) Polymers

Combustion ion chromatography (CIC) of (F-PS) polymers molded specimens was carried out on a METROHM COMBUSTION IC to determine the fluorine. The concentration of the calibration sample for CIC lied from 0.1 to 5 ppm. The sample weight of the analytes varied from 10-20 mg; samples were diluted according to the theoretical % F (dilution increased with increase in the theoretical % F), following the instructions of the instrument manufacturer. The samples were first combusted under oxidative environment and then injected automatically to IC where the injection volume varied from 5 to 200 μL. The retention time of the peak was around 4-4.5 min. The concentration of fluoride in the diluted samples was estimated according to the following formulae:
concentration of F⁻ in absorption solution (ppm)=concentration of F⁻ in diluted solution from calibration curve (ppm)×dilution factor (ppm);
concentration of F⁻ in sample (%)={Concentration of F⁻ in absorption solution (ppm)×final volume of absorber solution (mL)/wt of sample (μg)}×100
wherein absorption solution, diluted solution from the calibration curve and absorber solution are as defined above.

### Determination of Molecular Weights

Molecular weights were determined by NMR and/or GPC analyses according to known methods. Molecular weight (Mn) are expressed in g/mol, while E_{W} are expressed in g/eq.

### Measurements of Contact Angles (CA)

Contact angles towards water and hexadecane (C16) were evaluated on porous membranes (prepared as explained below) at 25° C. using Drop Shaper Analyzer DSA10 (Kriss GmbH, Germany), according to ASTM D 5725-99. For porous membranes, measurements were taken only on the upper side (air interface) of the membranes.

### Preparation of Compostions (C^{L}) (Dope Solutions)

Dope solutions were prepared by adding the tested polymer [polymer (r-PESU) or polymer (F-PS) according to the invention] to a solvent (DMAC or NMP) and stirring with a mechanical anchor for several hours at room temperature.

### Porous Membrane Preparation

Flat sheet porous membranes were prepared by filming each dope polymer solution over a suitable smooth glass support by means of an automatized casting knife. Membrane casting was performed by keeping the temperatures of the dope solutions, the casting knife and the support at 25° C., so as to prevent premature precipitation of the polymer. The knife gap was set to 250 μm. In all experiments, the polymer concentration was 25% w/w. After casting, polymeric films were immediately immersed in a coagulation bath in order to induce phase inversion. The coagulation bath consisted of pure DI water. After coagulation, the membranes were washed several times in pure water during the following days to remove residual traces of solvent. The membranes were stored (wet) in water.

### Measurement of the Gravimetric Porosity of Porous Membranes

The gravimetric porosity of a membrane is defined as the volume of the pores divided by the total volume of the membrane. Gravimetric porosities of the membranes was measured using pure IPA as wetting fluid according to the procedure described, for instance, in the Appendix of SMOLDERS, K., et al. Terminology for membrane distillation.

Desalination. 1989, vol. 72, p. 249-262. Perfectly dry membrane specimens were weighed and impregnated in IPA for 24 h; after this time, the excess of the liquid was removed with a tissue paper, and the membranes' weight was measured again. Finally, from the weights of dry and wet membrane specimens, porosity was calculated using the following formula:

$$ɛ = \frac{Wet - Dry}{{ρ}_{liquid}} / ( \frac{Wet - Dry}{{ρ}_{liquid}} ) + \frac{Dry}{{ρ}_{Polymer}}$$

wherein:
Wet is the weight of the wet membrane specimen,
Dry is the weight of the dry membrane specimen,
ρ_{liquid} is the IPA density (0.785 g/cm³) and
ρ_{polymer} is the polymer density

### Measurement of Mechanical Properties

The mechanical properties of the flat sheet porous membranes were assessed at room temperature (23° C.) following the ASTM D 638 standard procedure (type V, grip distance=25.4 mm, initial length Lo=21.5 mm). Velocity was between 1 and 50 mm/min. The test specimens of flat sheet porous membranes stored in water were took out from the container boxes and immediately tested.

### Preparation of Non-Porous Dense Films (F)

Non-porous, flat dense polymeric films for the performance of blood coagulation tests were prepared from dope solutions containing 20% w/w polymer and DMAc as solvent and by filming each dope solution over a suitable smooth glass support by means of an automatized casting knife at 40° C. The knife gap was set at 500 μm. After casting the films, the solvent was allowed to evaporate in a vacuum oven at 130° C. for 4 hours.

### Blood Coagulation Tests (Determination of the Partial Thromboplastin Time)

Partial thromboplastin time of blood contacted with non-porous dense films was evaluated (in duplicate) according to F2382-04 (Reapproved 2010) [Standard Test Method for Assessment of Intravascular Medical Device Materials on Partial Thromboplastin Time (PTT)].

4 cm² (2×2 cm) specimens of non-porous dense films obtained from (r-PESU) and from the (F-PS) of Example 21 were sterilized with 30-35 kGy and covered with 1 ml of citrated plasma, then incubated at 37° C. for 15 minutes. After incubation, the test specimens were contacted with a solution of rabbit brain cefalin (RCB) and with a solution of CaCl.

Average PPT was evaluated on the test and also on polypropylene tubes contacted with 1 ml plasma (negative controls), 4 mm glass beads (positive controls) and natural rubber (biomaterial reference; moderate coagulation activator). The clotting time values for the positive control, for the biomaterial reference control and of the specimens from (r-PESU) and from the (F-PS) of Example 21 was calculated as percent of the negative control using the following equation:

$$\% Negative Control = ( \frac{Average clotting time ( s ) of sample )}{( Average clotting time ( s ) of negative controls} ) \times 100$$

### Legend

In the formulae reported in the Examples, A represents a group A_{T}-O— wherein A_{T} is selected from CF₃—, —CF₂Cl, —CF₂H group(s) or is the same group on the right side of the (R_{f}-III) chain. An (R_{f}-III) is as defined above wherein the a1/a2 ratio is specified at each occurrence.

### Syntheses of PFPE Oligomers

### Example 1—Synthesis of a PFPE Oligomer (OL-B) of Formula

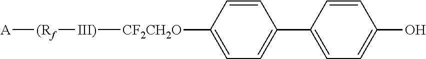

wherein a1/a2 in (R_{f}-III)=1.5; Mw=1,920; Ew=1,049

### Step a)—Preparation of a PFPE Nonaflate of PFPE Alcohol (I-A) of Formula A-(R_{f}-III)-CF₂CH₂OSO₂(CF₂)₂CF₃ (wherein A and R_{f}-III are as Defined Above)

A glass reactor was charged with triethylamine (TEA) (49.5 g, 490 meq) and perfluoro-1-butanesulfonyl fluoride (123 g, 408 meq) under mechanical stirring. The internal temperature of the reaction mass was lowered to −5/+5° C. using a dry ice bath. PFPE alcohol (I-A) M_{W} 1580 E_{W} 863 (327 g, 380 meq) of formula:
was added drop-wise under vigorous stirring. After that, the reaction mass was warmed up at room temperature, under mechanical stirring. The reaction was monitored by ¹⁹F-NMR. After 1 hour at room temperature, a sample was taken for NMR analysis; the analysis showed a 70% conversion of the hydroxyl end groups into nonaflate end groups. The internal temperature was increased up to 60° C. until completion of the reaction. After complete conversion (i.e. complete disappearance of the fluorine NMR signals in the —CF₂CH₂OH end groups), the reaction mass was cooled at room temperature and the product was washed twice with ethanol (200 g per washing). The organic phase was separated and the solvent was stripped at 70° C. under vacuum. The target PFPE-nonaflate was isolated with a purity >96% and a yield >90%. The typical diagnostic ¹⁹F-NMR signals of the PFPE nonaflate resonate at −110 ppm, while the diagnostic peak of any perfluorosulfonate (hydrolysed nonaflate) resonates at −114 ppm.
   The calculated Mn was 2,146 and the Ew was 1,170.

### Step b)—Reaction of the PFPE Nonaflate of Step 1 with 4,4′dihydroxy-diphenyl

A 4-necked 2 L glass reactor equipped with a water-cooled condenser, a magnetic stirring bar and a dropping funnel was kept under inert atmosphere by flowing N₂ for 20 min. The reactor was maintained under static inert atmosphere by means of a nitrogen-filled balloon kept above the condenser. The reactor was then loaded at 20° C. with 150 g (1613 meq) of 4,4′dihydroxy-diphenyl, 700 ml of DMSO and 118.7 g (860 mmoles) of K₂CO₃. 530 g (430 meq) of the PFPE nonaflate prepared in Step 1, diluted in 500 ml of HFX, was dropped in the reactor in 240 min. with vigorous stirring (1100 rpm) at 65° C. The mixture was kept at 65° C. and stirred at 1100 rpm for further 8 hrs. NMR analysis confirmed the completion of the reaction. The crude reaction mass was worked-up was follows:
addition of 300 ml HFX under stirring;
separation of the bottom fluorinated phase by centrifugation;
two washings with water;
solvents evaporation.
   The yield was 90 mol %.

### Example 2—Synthesis of a PFPE-oligomer (OL-B) of Formula

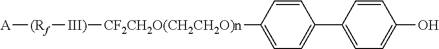

wherein wherein a1/a2 in (R_{f}-III)=1.5 and n=1.8; Mn=2,070; Ew=1,131

### Step a)—Preparation of a PFPE Tosylate of PFPE alcohol (I-B) of Formula A-(R_{f}-III)-CF₂CH₂(OCH₂CH₂)ₙOSO₂Ph-pCH₃ (wherein A, R_{f}-III and n are as Defined Above)

A 4-necked 2 L glass reactor equipped with a water-cooled condenser, a magnetic stirring bar and a dropping funnel was kept under inert atmosphere by flowing N₂ for 20 min. The reactor was maintained under static inert atmosphere by means of a nitrogen-filled balloon kept on top of the condenser. The reactor was then loaded at 20° C. with 137.6 g (724 meq) of tosylchloride, 45.7 g (452 meq) of triethylamine and 320 ml of CH₂Cl₂. The temperature was increased at 45° C. PFPE alcohol (I-B) (429 g; 452 meq), diluted with 80 ml of CH₂Cl₂, was dropped in 60 min. under vigorous stirring (1100 rpm). The mixture was kept at 45° C. and at 1100 rpm for further 3 hrs. Then the temperature was lowered to 20° C. and the reaction was continued at this temperature for 12 hrs. NMR analysis confirmed the completion of the reaction (complete disappearance of the fluorine signals in the —CF₂CH₂OH end groups). The crude reaction mass was worked-up as follows:
solvent evaporation;
addition of HFX (bis-trifluoromethylbenzene);
phase separation;
washing of the bottom layer by a water/ethanol solution;
water/solvent evaporation;
product filtration.

The yield was 95 mol %.

### Step b)—Reaction of the PFPE Tosylate of Step a) with 4,4′dihydroxy-diphenyl

The same procedure as in Example 1, step b) was followed, with the following reagents and under the following conditions:
80.2 g (872 meq) of 4,4′dihydroxy-diphenyl;
425 mL DMSO;
60.1 g (436 mmoles) K₂CO₃;
PFPE tosylate of Step a): 234 g (210 meq), diluted in 500 ml of HFX, dropped in the reactor in 240 min. with vigorous stirring (1100 rpm). Reaction time and temperature after completion of the addition: 100° C. for a further 4 hrs (stirring at 1100 rpm). The % conversion was quantitative with respect to the starting PFPE alcohol.

### Example 3—Synthesis of a PFPE-oligomer (OL-B) of Formula

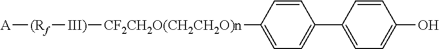

wherein a1/a2 in (R_{f}-III)=1.5 and n=1; Mn=2,000; Ew=1,097

The same procedure as in Example 2 was followed starting from PFPE alcohol (I-C). The % conversion was quantitative with respect to the starting PFPE alcohol.

### Example 4—Synthesis of a PFPE-oligomer (OL-B) of Formula

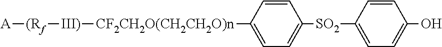

wherein a1/a2 in (R_{f}-III)=1.5 and n=1; Mn=2,095; Ew=1,145

The same procedure as in Example 2 was followed starting from PFPE alcohol (I-C), using 4,4′dihydroxydiphenylsulfone instead of 4,4′-dihydroxy-diphenyl. The % conversion was quantitative with respect to the starting PFPE alcohol.

### Example 5—Synthesis of a PFPE-oligomer (OL-BB) of Formula

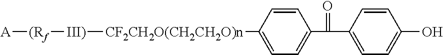

wherein a1/a2 in (R_{f}-III)=1.5 and n=1; Mn=2,030; Ew=1,109

The same procedure as in Example 2 was followed starting from PFPE alcohol (I-C), using 4,4′dihydroxydiphenylketone instead of 4,4′-dihydroxy-diphenyl. The % conversion was quantitative with respect to the starting PFPE alcohol.

### Example 6—Synthesis of a PFPE-oligomer (OL-BB) of Formula

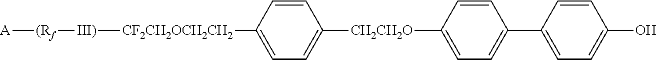

wherein a1/a2 in (R_{f}-III)=1.5; Mn=2,178; Ew=1,190

### Step 1) Synthesis of a PFPE Nonaflate (OL-B_{SU}) of Formula

A-(R_{f}-III)-CF₂CH₂OCH₂CH₂CH₂CH₂OSO₂(CF₂)₂CF₃

wherein a1/a2 in (R_{f}-III)=1.5; Mn=2,452; Ew=1,340

The nonaflate of 1,4-bis(2-hydroxyethyl)benzene was prepared by reacting 1,4-bis(2-hydroxyethyl)benzene with perfluorobutanesulfonylfluoride, in the presence of a tertiary amine in accordance with known methods.

This compound was reacted with PFPE alcohol (I-A) at an equivalent ratio nonaflate compound/PFPE alcohol (I-A) of 4, in the presence of a stoichiometric molar amount of tert-BuOK (with respect to the —OH groups). The reaction mass was treated with cold water in order to extract all formed salts. Then the organic residue was treated with HFX/DMSO to isolate the title product.

### Step b)—Reaction of the Oligomer (OL-B_{SU}) of Step 1) with 4,4′-dihydroxy-diphenyl

The PFPE oligomer (OL-B_{SU}) of Step 1) was reacted with 4,4′-dihydroxy-diphenyl according to the procedure described in Example 1, step 2. After work up, the PFPE oligomer (BB) having the above-reported structure was obtained. The % conversion was quantitative with respect to the starting PFPE alcohol.

### Example 7—Synthesis of a PFPE-oligomer (OL-BA) of Formula

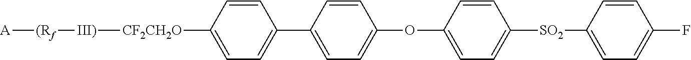

wherein a1/a2 in (R_{f}-III)=1.5; Mn=1,050.

The title compound was synthesized by first preparing an oligomer (OL-B) of formula:

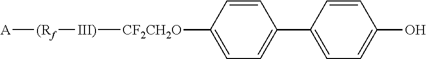

wherein A=CF₃ and a1/a2 in (R_{f}-III)=1.5 and then by reacting this intermediate with 4,4′-difluorodiphenylsulfone in the presence of a stoichiometric amount of tert-BuOKas described in Example 6. Oligomer (OL-BA) was isolated after work-up of the reaction mixture. The intermediate was prepared according to the procedure illustrated in Example 1, starting from PFPE alcohol (I-D). The % conversion was quantitative with respect to the starting PFPE alcohol.

### Example 8—Synthesis of an Oligomer (OL-A) of Formula

F—Ar—S(O₂)Ar—O—CH₂CF₂O—(R-III)-CF₂CH₂—O—Ar—S(O₂)—Ar—F

PFPE alcohol (I-A) was reacted with difluorodiphenylsulfone (DFDPS) at an equivalent ratio of 2.2:1, in the presence of a stoichiometric molar amount of tert-BuOK (with respect to the —OH groups). The reaction mass was treated with cold water in order to extract all formed salts. Then the organic residue was treated with HFX/DMSO to isolate the title product. Mn (NMR)=2002 g/mol; E_{W}=1094 g/eq

### Example 9—Synthesis of an Oligomer (OL-A) of Formula

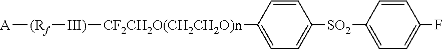

wherein a1 and a2 in (R_{f}-III) and are as in PFPE alcohol (I-B).

In a 3-neck round bottom flask equipped with a magnetic stirrer, oil bath and N₂ inlet, 45.02 g (25.35 mmol) of PFPE alcohol (I-B) and 32.225 g (126.74 mmol) of 4,4′-difluorodiphenylsulfone were charged together with 2.0 eq. K₂CO₃ (50.69 mmol) in neat condition. The reaction was continued for about 3.5 hrs under heating at an internal temperature of 200-205° C. Thereafter, the reaction mixture was quenched with water and the product was extracted in hexafluoroxylene (HFX). During this procedure the pH was maintained at about 2; an emulsion formed and IPA (1.5 to 2 volumes with respect to the HFX layer) was added until break of the emulsion was observed and two layers formed. The organic layer was separated using a separating funnel and further washed thoroughly with MeOH to completely remove the DFDPS excess. The product obtained after evaporation of the solvent from the organic layer was dried under vacuum oven at 120° C. The structure of the product was confirmed by NMR spectroscopy.

### Syntheses of (F-PS) According to the Invention

### Example 10—Synthesis of a (F-PS) Using the PFPE Oligomer of Example 1

A (F-PS) according to the invention was synthesized using the PFPE oligomer of Example 1, 4,4′-difluorodiphenylsulfone (DFDPS) and 4,4′-dihydroxydiphenylsulfone (DHDPS) as reagents in the presence of Na₂CO₃ as base in the following equivalent ratio: DFDPS:DHDPS:PFPE oligomer:Na₂CO₃=1:0.97:0.012:1.1.

In a first step, DFDPS (1.39 g, 5.46 mmoles, 10.9 meq) and sulfolane (25 ml) were charged in a 3-necked 1000 ml round bottom flask fitted with a nitrogen inlet, condenser with a receiver and with an overhead stirrer. The PFPE oligomer of Example 1 (3 g, 1.56 mmoles, 2.86 meq) was charged and the temperature was raised to 150° C. with an oil bath under nitrogen flow. After DFDPS dissolved completely, heating was continued for about one hour, then Na₂CO₃ (0.41 g, 3.9 mmoles, 7.8 meq.) was added together with about 5 ml sulfolane and the temperature of the oil bath was raised up to 210° C. The reaction mixture was kept under stirring for a total time of 3.5 hours to ensure complete consumption of the PFPE oligomer.

In a second step, the remaining amounts of Na₂CO₃ (0.128 mol, 13.58 g, 0.256 meq) and DFDPS (0.113 mmol, 28.84 g, 0.226 meq) and DHDPS (0.119 mol, 29.75 g, 0.238 meq) together with 136 ml of sulfolane were added to the reaction mixture and the polycondensation reaction was continued for further 6 hours at 210° C. Every half hour during this time, an aliquot was taken and suspended in dichloromethane to check the molecular weight by GPC analysis. When the molecular weight became constant [final MW of about 34,500; polydispersity index (PDI)=3], the reaction was stopped. The mixture was cooled down to 100° C., then the resulting viscous polymer solution was slowly poured into an excess of deionized (DI) water under constant stirring until precipitation of the title (F-PS) in the form of a powder. The precipitated (F-PS) powder was collected by filtration and washed thoroughly with DI water followed by hot DI water to remove any residual solvent. After washing, the residual solvent (% RS, w/w) value determined by gas chromatography GC was found as 0.11. Finally, the (F-PS) powder was dried overnight at 120° C. in an oven. The yield was about 99%. The (F-PS) had 4% wt PFPE content corresponding to a 2.2% wt fluorine content. The ¹⁹F-NMR spectrum showed no degradation of the PFPE oligomer. Part of the (F-PS) was then subjected to Soxhlet extraction in hexafluoroxylene (HFX) and part to reprecipitation/coagulation from NMP and HFX to extract any possibly still present PFPE oligomer or its degraded by-products in the (F-PS). GPC of the HFX washings from the Soxhlet extraction and of the NMP/HFX mother liquor from coagulation did not show any PFPE oligomer of degradation product thereof. This confirmed the covalent incorporation of the PFPE oligomer in the polymer backbone.

### Example 11—Synthesis of a (F-PS) Using the PFPE Oligomer of Example 2

A (F-PS) according to the invention was synthesized using the PFPE oligomer of Example 2, DFDPS (31.1 g), DHDPS (29.7 g) as reagents in the presence of Na₂CO₃ (15.3 g) as base in such a way as to obtain the following equivalent ratio: DFDPS:DHDPS:PFPE oligomer:Na₂CO₃=1.02:0.99:0.014:1.2.

The procedure of Example 10 was followed, adjusting the amount of reagents to obtain the indicated equivalent ratio.

The analyses confirmed the obtainment of the (F-PS) covalently incorporating the PFPE oligomer in an amount of 4.5% wt, corresponding to a 2.7% wt content of fluorine. The yield was quantitative.

### Example 12—Synthesis of a (F-PS) Using the PFPE Oligomer of Example 3

A (F-PS) according to the invention was synthesized using the PFPE oligomer of Example 3, DFDPS (30.0 g), 4,4′-dihydroxy diphenyl (DHDPS) (29.2 g) as reagents in the presence of K₂CO₃ (19.5 g) as base in such a way as to obtain the following equivalent ratio: DFDPS:DHDPS:PFPE oligomer:K₂CO₃=1.00:0.99:0.0080:1.2.

The procedure of Example 10 was followed, adjusting the amount of reagents to obtain the indicated equivalent ratio.

The analyses confirmed the obtainment of a (F-PS) covalently incorporating the PFPE oligomer in an amount of 2.7% wt, corresponding to a 1.6% wt fluorine content.

### Example 13—Synthesis of a (F-PS) Using the PFPE Oligomer of Example 4

A (F-PS) according to the invention was synthesized using the PFPE oligomer of Example 4, DFDPS (31 g), DHDPS (29.8 g) as reagents in the presence of Na₂CO₃ (14.1 g) as base in such a way as to obtain the following equivalent ratio: DFDPS:DHDPS:PFPE oligomer:Na₂CO₃=1.01:0.99:0.015:1.1.

The procedure of Example 10 was followed, adjusting the amount of reagents to obtain the indicated equivalent ratio.

The analyses confirmed the obtainment of a (F-PS) covalently incorporating the PFPE oligomer in an amount of 6.2% wt, corresponding to a 3.7% wt fluorine content.

### Example 14—Synthesis of a (F-PS) Using the PFPE Oligomer of Example 5

A (F-PS) according to the invention was synthesized using the PFPE oligomer of Example 5, DFDPS (35 g) and DHDPS (33.2 g) as reagents in the presence of Na₂CO₃ (17.1 g) as base in such a way as to obtain the following equivalent ratio: DFDPS:DHDPS:PFPE oligomer:Na₂CO₃=1.02:0.99:0.015:1.2.

The procedure of Example 10 was followed, adjusting the amount of reagents to obtain the indicated equivalent ratio.

The analyses confirmed the obtainment of a (F-PS) covalently incorporating the PFPE oligomer in an amount of 6.2% wt, corresponding to 3.7% wt fluorine content.

### Example 15—Synthesis of a (F-PS) Using the PFPE Oligomer of Example 6

A (F-PS) according to the invention was synthesized using the PFPE oligomer of Example 5, DFDPS (30 g) and DHDPS (28.9 g) as reagents in the presence of Na₂CO₃ (13.5 g) as base in such a way as to obtain the following equivalent ratio: DFDPS:DHDPS:PFPE oligomer:Na₂CO₃=1.02:1.00:0.013:1.1.

The procedure of Example 10 was followed, adjusting the amount of reagents to obtain the indicated equivalent ratio.

The analyses confirmed the obtainment of a (F-PS) covalently incorporating the PFPE oligomer in an amount of 4.5% wt, corresponding to 2.7% wt of fluorine.

### Example 16—Synthesis of a (F-PS) Using a PFPE Alcohol (I-B)

A (F-PS) according to the invention was synthesized using PFPE alcohol (I-B), DFDPS (35 g) and DHDPS (33.4 g) as reagents in the presence of Na₂CO₃ (17.2 g) as base in the following equivalent ratio: DFDPS:DHDPS:PFPE alcohol (I-B):Na₂CO₃=1.02:0.99:0.014:1.2.

The procedure of Example 10 was followed, adjusting the amount of reagents to obtain the indicated equivalent ratio.

The analyses confirmed the obtainment of a (F-PS) covalently incorporating the PFPE alcohol (I-B) in an amount of 4.4% wt, corresponding to 2.7% wt fluorine content.

### Example 17 (Reference Example)—Synthesis of a (F-PS) Using PFPE Alcohol (I-A)

Example 10 was repeated using PFPE alcohol (I-A), DFDPS (35 g) and DHDPS (33.4 g) as reagents in the presence of Na₂CO₃ (17.2 g) as base in such a way as to obtain the following equivalent ratio: DFDPS:DHDPS:PFPE alcohol (I-A):Na₂CO₃=1.02:0.99:0.012:1.2.

The resulting powder was analyzed by ¹⁹F-NMR. The results showed the typical signals of the (R_{f}-III) chain, but the diagnostic F signals of the —CF₂CH₂O— preterminal groups in the PFPE segment of the expected (F-PS) were absent and replaced by —CF₂H signals.

### Example 18—Synthesis of a (F-PS) Using the PFPE Oligomer of Example 7

A (F-PS) was synthesized using the PFPE oligomer of Example 7 and the (rPESU) referred to in the Materials section, in the presence of Na₂CO₃ as base in the following equivalent ratio: rPES:PFPE oligomer:Na₂CO₃=1.00:2.00:2.00.

The PFPE oligomer of Example 7 (1.49 g, 2.28 mmol), r-PESU (10.5 g, 1.14 mmol) and Na₂CO₃ (0.242 g, 2.28 mmol) were placed in sulfolane in a reactor and reacted at a temperature of 200-205° C. for 3.5 hours. Thereafter, the reaction mass was coagulated into water and filtered. The white residue was thoroughly washed with water to remove the solvent and was dried overnight in an oven at 120° C. The polymers structure was analyzed by ¹⁹F-NMR spectroscopy. Furthermore, the progress of the reaction was studied by disappearance of the —OH end groups and the appearance of fluoride ions in the coagulation water. The resulting (F-PS) polymer (MW=68,000) was found to have a 12.3% wt PFPE content, corresponding to about 7.4% wt fluorine content. 15 ppm fluoride ions were found in the coagulation water, which confirmed the reaction of the rPES end groups with the PFPE oligomer, consistent with the expected value for end-groups reaction. A corresponding reduction of the —OH groups to 1292 ppm was observed.

### Example 19—Synthesis of a (F-PS) Using the PFPE Oligomer of Example 8

Following the procedure of Example 18, a (F-PS) was synthesized using the PFPE oligomer of Example 8 and the (r-PESU) referred to in the Materials section in the presence of Na₂CO₃ as base in the following equivalent ratio: r-PESU:PFPE oligomer:Na₂CO₃=1.00:0.49:1.1.

The (F-PS) was found to have a MW of 29,000, a content of PFPE oligomer of about 10% wt, which corresponded to about 6.3% wt fluorine.

35 ppm of fluoride ions were found in the coagulation water, which confirmed the reaction of the rPES end groups with the PFPE oligomer, consistent with the expected value for end-groups reaction. A corresponding reduction of the —OH groups to 1615 ppm was observed.

### Example 20—Synthesis of a (F-PS) Using the PFPE Oligomer of Example 9

A (F-PS) was synthesized using the PFPE oligomer of the Example 9 and the (r-PESU) referred to in the Materials section in the presence of Na₂CO₃ as base in such a way as to obtain the following equivalent ratio: rPES:PFPE oligomer:Na₂CO₃=1:1.21:2.

In a 500 mL 4-neck round-bottom flask equipped with an overhead stirrer, N₂ inlet and heating bath, 35 g (3.302 mmol) of r-PESU (Mw about 32,000) was charged together with 100 mL sulfolane at 100° C. After dissolving the r-PESU, 14.16 g (4.0 mmol) of PFPE oligomer was added. The mixture was stirred rigorously to make it homogeneous. Thereafter, 0.371 g of Na₂CO₃ was added and the bath temperature was increased to 220° C. to maintain the inner temperature at 206° C. The reaction was continued for further 4 hrs with inner temperature of 206° C. while the increase of molecular weight was monitored by online GPC (final Mw about 61,500; PDI=4.9). After cooling down the temperature to 100° C., the resulting viscous polymer solution was slowly poured into an excess of DI water under constant stirring. The precipitated polymer powder was collected by filtration and washed thoroughly with DI water, followed by hot DI water to remove any residual solvent. After final washing, the residual solvent (% RS) value determined by GC was found as 0.07. Finally, the (F-PS) powder was collected after drying overnight at 120° C. under oven. The polymer structure was analyzed by NMR spectroscopy. Furthermore, the progress of the reaction was monitored by observing the consumption of the —OH end group (titration).

Finally, to remove any unreacted PFPE oligomer, the (F-PS) was Soxhlet extracted overnight with hexafluoroxylene (HFX). After extraction the (F-PS) was washed with methanol and dried overnight under vacuum oven at 140° C. for. The removal of the PFPE oligomer was confirmed by GPC, using a column suitable for the determination of compounds having a molecular weight ranging from 1 kDa to 5 kDa.

The fluorine content was 1.83% wt.

### Example 21—Synthesis of a (F-PS) Using the PFPE Oligomer of Example 9

The procedure illustrated in Example 19 was followed, using the following equivalent ratio: rPES:PFPE oligomer:Na₂CO₃=1:1.278:2.5.

The amounts of reagents, solvents and conditions (were different from Example 20) are listed below:

40 g (4.075 mmol) of r-PESU

17.372 g (5.21 mmol) PFPE oligomer

0.6042 g of Na₂CO₃ (2.5 eq with respect to —OH group)

Reaction time at 206° C.: 10 hrs

Mw about 79,000; PDI=5.9.

The fluorine content was 2.93.

### Test Results

### Contact Angle Measurements

The following table reports the results of measurements of contact angles on membranes casted from the (F-PS) of Examples 10 and 11 against Veradel® 3300 polyethersulfone (PS).

| | | | Contact angle |
|---|---|---|---|
| Polymer used to | | Contact angle | against n- |
| prepare the film | F (%) | against water | hexadecane |
| Veradel ® 3300 PESU | 0 | 87.7 + 1.5 | 29.0 + 0.9 |
| Example 10 | 2.2 | 104.6 + 1.1 | 61.9 + 1.2 |
| Example 11 | 2.7 | 101.5 + 0.7 | 63.2 + 1.6 |

The casted membranes were prepared by casting solutions of each polymer in DMAc (10% w/v) onto a flat bottom Petri dish, followed by drying in an oven by sequential heating at 100° C. (16 hrs) and then at 120° C., 140° C. and 160° C. each for 2 hrs in order to slowly remove the solvent. After cooling down to the room temperature, the membranes were removed from the Petri dishes by dipping in water. Thereafter the membranes were washed with methanol and further dried overnight under vacuum at 120° C.

The following table reports the results of measurements of contact angles on porous membranes obtained from r-PESU and from the (F-PS) of Examples 20 and 21.

| Polymer used | | | Contact angle |
|---|---|---|---|
| to prepare the | | Contact angle | against n- |
| membrane | F (%) | against water | hexadecane |
| r-PESU | 0 | 47.8 | 9.5 |
| Example 20 | 1.83 | 71.7 | 29.5 |
| Example 21 | 2.93 | 92.5 | 30.1 |

The results show that flat sheet porous membranes have similar gravimetric porosity and that the membranes obtained from the (F-PS) of the invention are endowed with improved hydro and oleophobicity.

### Mechanical Properties of Flat Sheet Porous Membranes

The following table reports the results of measurements of mechanical properties on porous membranes obtained from r-PESU and from the (F-PS) of Examples 20 and 21.

| | | Average | Average | |
|---|---|---|---|---|
| Polymer used | Average | Stress | Strain | |
| to prepare the | Modulus | @ Break | @ Break | Porosity |
| membrane | [MPa] | [MPa] | [%] | (%) |
| r-PESU | 239.3 | 6.44 | 7.0 | 75 |
| Example 20 | 282.1 | 7.67 | 6.1 | 75 |
| Example 21 | 297.6 | 9.29 | 23.1 | 75 |

The results show also an improvement in mechanical properties of membranes obtained from the F-PS of the invention.

### Blood Coagulation Tests

The % negative control value of specimens obtained from (r-PESU) was 88.4, while the value obtained for the specimens obtained from Example 21 was 96.0%. By comparing these percentages with the test acceptance criteria reported in F2382-04, it can be appreciated that both (r-PESU) and the (F-PS) of Example 21 are minimal coagulation activators, but the (F-PU) of Example 21 induces less coagulation then a (r-PESU).

### Example 22—Synthesis of a (F-PS) Using PFPE alcohol (1-B)

A (F-PS) according to the invention was synthesized by charging 4-4′ biphenol (38.07 g, 0.2044 mol, 0.988 eq), PFPE alcohol (I-B) (4.33 g, 0.00249 mol, 0.012 eq), 4-4′-DFDPS (52.63 g, 0.207 mol, 1.0 eq) and K₂CO₃ (EF 80 grade) (29.44 g, 0.21301 mol, 1.03 eq), along with toluene (67.47 g) and NMP (202.45 g) as solvents in a 4-necked 500 ml kettle flask fitted with a nitrogen inlet, water condenser with receiver and with an overhead stirrer (Heidolph RZR 2052 control-type stirrer). The reaction mixture was heated at 160° C. for 3 hrs with an oil bath and then the temperature was raised to 180° C. for 10 hrs, stirring at 180 rpm under nitrogen atmosphere.

When the molecular weight became constant (samples were taken over the time in dichloromethane to measure the molecular weight by GPC analysis), the polycondensation reaction was stopped. The reaction mixture was cooled down to 100° C., then the viscous polymer solution was pressure-filtered through a 2.7 μm glass-microfiber filter at 40 psi to remove any unreacted salts. Thereafter, the resulting polymer solution was slowly poured into an excess of DI water under constant stirring until precipitation of the (F-PS) polymer in the form of a powder. The precipitated (F-PS) powder was collected by filtration and washed thoroughly with DI water followed by hot DI water to remove any residual solvent. After final washing, the residual solvent (% RS, w/w) value determined by GC was found as 0.13. Finally, the (F-PS) polymer powder was dried overnight at 110° C. in a vacuum oven.

The yield was 93% and the molecular weight, measured by GPC analysis, was 41000.

The ¹⁹F-NMR spectrum analysis confirmed the covalent incorporation of PFPE alcohol (I-B) in the polymer backbone in an amount of 4.1% wt, corresponding to a 2.3% wt fluorine content.

### Example 23—Synthesis of a (F-PS) Using PFPE Alcohol (1-B)

A (F-PS) according to the invention was synthesized by charging 4-4′ biphenol (38.07 g, 0.2044 mol, 0.988 eq), PFPE alcohol (I-B) (4.33 g, 0.00249 mol, 0.012 eq), 4-4′ DFDPS (52.63 g, 0.207 mol, 1.0 eq), and K₂CO₃ (EF 80 grade) (29.44 g, 0.21301 mol, 1.03 eq) along with sulfolane (202 g) and chlorobenzene (67 g) as solvents in a 4-necked 500 ml kettle flask fitted with a nitrogen inlet, water condenser with a receiver and with an overhead stirrer (Heidolph RZR 2052 control type stirrer). The reaction mixture was heated at 160° C. for 3 hrs with an oil bath and then the temperature was raised to 210° C. for 6 hrs, stirring at 180 rpm under a nitrogen atmosphere.

The procedure of Example 22 was followed for monitoring the progress of the reaction and for isolating the polymer (F-PS).

The yield was found 90% with a molecular weight of the (F-PS) polymer measured by GPC analysis of 81000.

The 19F-NMR spectrum analysis confirmed the covalent incorporation of PFPE alcohol (I-B) in the polymer backbone in an amount of 4.0% wt PFPE, corresponding to a 2.2% wt fluorine content.

Example 24—Synthesis of a F-PS) using PFPE alcohol (1-B)

The procedure of Example 23 was followed, adjusting the amount of reagents to obtain the following molar ratio: DFDFS:4-4′biphenol:PFPE alcohol (I-B):K₂CO₃=1.0:0.974:0.026:1.03.

At the end of the reaction, the yield was found 92% with a molecular weight of the (F-PS) polymer measured by GPC analysis of 42000.

The ¹⁹F-NMR spectrum analysis confirmed the covalent incorporation of the PFPE alcohol (I-B) in the polymer backbone in an amount of 6.8% wt PFPE, corresponding to a 4.0% wt fluorine content.

### Example 25 (Comparative Example)—Synthesis of a Radel® PPSU

A Radel® PPSU having a Mw of 41,000 was obtained from 4-4′ biphenol (33.52 g, 0.180 mol) and 4-4′ dichlorodiphenylsulfone (DCDPS) (53.24 g, 0.185 mol), using and K₂CO₃ (EF 80 grade) (28.61 g, 0.207 mol) as base and sulfolane (200 g) and chlorobenzene (60 g) as solvents according to a known method.

### Test Results

### Contact Angle Measurements

The following table reports the results of measurements of contact angles on flat dense films (F) casted from the (F-PS) polymers of Examples 22, 23 and 24 against a film obtained from polyphenylsulfone (PPSU) Comparative example 25. For the preparation of the films, the procedure illustrated in the Methods section was followed, with the difference that NMP instead of DMAc was used for dissolving the polymers.

| | | | Contact angle |
|---|---|---|---|
| Polymer used to | | Contact angle against | against n- |
| prepare the film | F (%) | water | hexadecane |
| Example 25 | 0 | 76.6 + 1.8 | 34.6 + 1.2 |
| Example 22 | 2.3 | 100.2 + 3.4 | 66.5 + 1.6 |
| Example 23 | 2.2 | 97.3 + 0.7 | 64.2 + 1.9 |
| Example 24 | 4.0 | 100.2 + 1.1 | 65.4 + 1.3 |

These results show that flat dense casted films prepared from (F-PS) of the invention are endowed with improved hydro and oleophobicity with respect a non-fluorinated PPSU of Comparative example 25.

1. A fluorinated aromatic sulfone polymer (F-PS) comprising:
recurring units (A) derived from at least one monomer (A), wherein monomer (A) is at least one dihalo-diaryl sulfone;
recurring units (B) derived from at least one monomer (B), wherein monomer (B) is at least one aromatic diol;
at least one unit (PFPE) derived from at least one PFPE alcohol, wherein the PFPE alcohol is at least one fully or partially fluorinated polyether alcohol,
said polymer (F-PS) having a fluorine content ranging from 0.1% to 10% wt.

2. The polymer (F-PS) according to claim 1 wherein units (A) are derived from at least one monomer (A) complying with formula (A-I): 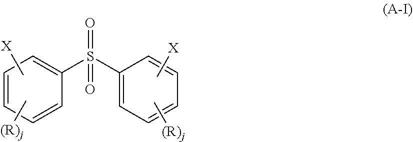
wherein:
each X, equal to or different from one another, is halogen;
each R, equal to or different from one another, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
each j, equal to or different from one another, is zero or is an integer from 1 to 4.

3. The polymer according to claim 2 wherein both X are fluorine or chlorine and both j are 0.

4. The polymer (F-PS) of claim 1 wherein units (B) are derived from at least one monomer (B) that is a diol HO—R_{diol}—OH, wherein R^{∘}_{diol} is independently selected from the following classes:
(a) a straight or branched hydrocarbon chain containing from 2 to 20 carbon atoms, optionally substituted with one or more hydroxyl groups and optionally interrupted by one or more arylene groups and/or heteroatoms independently selected from N, O and S;
(b) a C₃-C₁₂ cycloalkyl or a C₆-C₁₂ bicycloalkyl group, each optionally containing one or more heteroatoms independently selected from N, O and S and optionally substituted with one or more C₁-C₄ straight or branched alkyl groups and
(c) a group of formula —Ar-(T-Ar²)_{nT}—, wherein:
Ar¹ and Ar², equal to or different from one another at each occurrence, are independently an arylene group and
T is selected from the group consisting of: a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula: 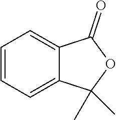
and n_{T} is 0 or an integer of 1 to 5;
(d) a 1,4:3,6-dianhydrohexitol sugar diol residue.

5. The polymer according to claim 4, wherein units (B) are derived from at least one of 1,4-bis(2-hydroxyethyl)benzene, 4,4′-dihydroxy diphenyl, 2,2-bis(4-hydroxyphenyl)propane or 4,4′-dihydroxydiphenylsulfone or 4,4′ dihydrohydiphenylketone.

6. The polymer (F-PS) of claim 1 wherein the at least one units (PFPE) are derived from a PFPE alcohol of formula (PFPE-1):
Z—O—R_{f}—Z (PFPE-1)
wherein:
(R_{f}) is a fluoropolyoxyalkylene chain having a number average molecular weight (Mₙ) ranging from 400 to 10,000 Da and comprising recurring units (R^{∘}) selected from:
(i) —CFX^{∘}O—, wherein X^{∘} is F or CF₃;
(ii) —CFX^{∘}CFX^{∘}O—, wherein X^{∘}, equal or different at each occurrence, is F or CF₃, with the proviso that at least one of X^{∘} is F;
(iii) —CF₂CF₂CW^{∘}₂O—, wherein each of W^{∘}, equal or different from each other is F, Cl, H;
(iv) —CF₂CF₂CF₂CF₂O—;
(v) —(CF₂)ⱼ_{^{∘}}—CFZ^{∘}—O— wherein j^{∘} ranges from 0 to 3 and Z^{∘} is a group of formula —OR_{f}^{∘}T^{∘}, wherein R_{f} is a fluoropolyoxyalkene chain comprising a number of repeating units from 0 to 10, said recurring units being independently selected from: —CFX^{∘}O—, —CF₂CFX^{∘}O—, —CF₂CF₂CF₂O—, or —CF₂CF₂CF₂CF₂O—, with each of each of X^{∘} being independently F or CF₃ and T^{∘} being a C₁-C₃ perfluoroalkyl group and
each Z, equal to or different from one another, represents a (i) hydrocarbon group containing one hydroxy group, said hydrocarbon group being partially fluorinated and optionally containing one or more ethereal oxygen atoms, or (ii) a C₁-C₃ haloalkyl group.

7. A process (P) for the manufacture of the polymer (F-PS) as defined in claim 1, said process (P) comprising:
copolymerizing a PFPE alcohol of formula (PFPE-1)
Z—O—R_{f}—Z (PFPE-1)
wherein:
(R_{f}) is a fluoropolyoxyalkylene chain having a number average molecular weight (Mₙ) ranging from 400 to 10,000 Da and comprising recurring units (R^{∘}) selected from:
(i) —CFX^{∘}O—, wherein X^{∘} is F or CF₃;
(ii) —CFX^{∘}CFX^{∘}O—, wherein X^{∘}, equal or different at each occurrence, is F or CF₃, with the proviso that at least one of X^{∘} is F;
(iii) —CF₂CF₂CW^{∘}₂O—, wherein each of W^{∘}, equal or different from each other is F, Cl, H;
(iv) —CF₂CF₂CF₂CF₂O—;
(v) —(CF₂)ⱼ_{^{∘}}—CFZ^{∘}—O— wherein j^{∘} ranges from 0 to 3 and Z^{∘} is a group of formula —OR_{f}^{∘}T^{∘}, wherein R_{f} is a fluoropolyoxyalkene chain comprising a number of repeating units from 0 to 10, said recurring units being independently selected from: —CFX^{∘}O—, —CF₂CFX^{∘}O—, —CF₂CF₂CF₂O—, or —CF₂CF₂CF₂CF₂O—, with each of each of X^{∘} being independently F or CF₃ and T^{∘} being a C₁-C₃ perfluoroalkyl group and
each Z, equal to or different from one another, represents a (i) hydrocarbon group containing one hydroxy group, said hydrocarbon group being partially fluorinated and optionally containing one or more ethereal oxygen atoms, or (ii) a C₁-C₃ haloalkyl group,
with:
at least one monomer (A) and at least one monomer (B); and/or
with a hydroxyl or halogen-terminated aromatic sulfone polymer, said polymer being free from units (PFPE) and being obtained by copolymerization reaction of at least one monomer (A) and at least one monomer (B);
wherein monomer (A) is a monomer of formula (A-I): 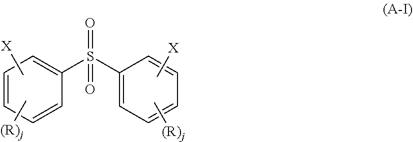
wherein:
each X, equal to or different from one another, is halogen;
each R, equal to or different from one another, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
each j, equal to or different from one another, is zero or is an integer from 1 to 4; and
monomer (B) is a diol HO—R_{diol}—OH, wherein R^{∘}_{diol} is independently selected from the following classes:
(a) a straight or branched hydrocarbon chain containing from 2 to 20 carbon atoms, optionally substituted with one or more hydroxyl groups and optionally interrupted by one or more arylene groups and/or heteroatoms independently selected from N, O and S;
(b) a C₃-C₁₂ cycloalkyl or a C₆-C₁₂ bicycloalkyl group, each optionally containing one or more heteroatoms independently selected from N, O and S and optionally substituted with one or more C₁-C₄ straight or branched alkyl groups and
(c) a group of formula —Ar¹-(T-Ar²)_{nT}—, wherein:
Ar and Ar², equal to or different from one another at each occurrence, are independently an arylene group and
T is selected from the group consisting of: a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula: 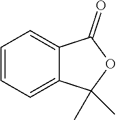
and n_{T} is 0 or an integer of 1 to 5;
(d) a 1,4:3,6-dianhydrohexitol sugar diol residue.

8. A composition (C) comprising:
at least one polymer (F-PS);
optionally, at least one polymer different from (F-PS);
at least one ingredient independently selected from: a liquid medium comprising at least one organic solvent, a pore-forming agent, a filler, a salt, a latent organic solvent and a surfactant.

9. A dense film comprising at least one layer obtained from the composition of claim 8.

10. A porous membrane comprising the composition of claim 8.

11. The porous membrane of claim 10 which is in the form of a tubular or hollow fiber.

12. A method for filtering a liquid phase and/or a gas phase comprising one or more solid contaminants, said method comprising contacting said liquid phase and/or gas phase comprising one or more solid contaminants with at least one porous membrane as defined in claim 10.

13. The use of at least one porous membrane as defined in claim 10 as component in an extracorporeal blood circuit or in a dialysis filter.

14. A method for purifying a blood product, said method comprising dialyzing said blood product across at least one porous membrane as defined in claim 10.

15. A catheter comprising at least one layer made from a dense film as defined in claim 9.

16. The polymer (F-PS) of claim 4 wherein the 1,4:3,6-dianhydrohexitol sugar diol residue is an isosorbide, isomannide or isoiodide residue, respectively complying with formulae (Bd-1)-(Bd-3):

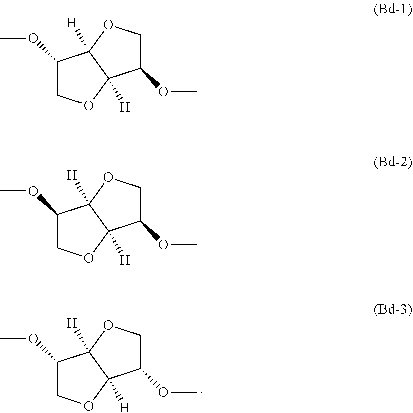

17. The polymer (F-PS) of claim 6 wherein each Z, equal to or different from one another, represents a (i) hydrocarbon group containing one hydroxy group, said hydrocarbon group being partially fluorinated and optionally containing one or more ethereal oxygen atoms, or (ii) a C₁-C₃ haloalkyl group selected from —CF₃, —CF₂Cl, —CF₂CF₂Cl, —C₃F₆Cl, —CF₂Br, —CF₂CF₃ and —CF₂H, —CF₂CF₂H.

18. The polymer according to claim 7 wherein in monomer (A-I) both X are fluorine or chlorine and both j are 0.

19. The polymer according to claim 7, wherein monomer (B) is at least one monomer selected from 1,4-bis(2-hydroxyethyl)benzene, 4,4′-dihydroxy diphenyl, 2,2-bis(4-hydroxyphenyl)propane or 4,4′-dihydroxydiphenylsulfone or 4,4′ dihydrohydiphenylketone.
